(19) United States
(12) Patent Application Publication
(10) Pub. No.: US 2017/0154374 A1
(43) Pub. Date: Jun. 1, 2017

(54) OUTPUT ADJUSTMENT AND MONITORING IN ACCORDANCE WITH RESOURCE UNIT PERFORMANCE

(71) Applicants: Marcos Alfonso Iglesias, Valley Park, MO (US); Kelly J. McLaughlin, Cobalt, CT (US); Arthur Paul Drennan, III, West Granby, CT (US); Willie F. Gray, North Granby, CT (US); Amber N. Walton, Greenwood, IN (US)

(72) Inventors: Marcos Alfonso Iglesias, Valley Park, MO (US); Kelly J. McLaughlin, Cobalt, CT (US); Arthur Paul Drennan, III, West Granby, CT (US); Willie F. Gray, North Granby, CT (US); Amber N. Walton, Greenwood, IN (US)

(21) Appl. No.: 15/363,087

(22) Filed: Nov. 29, 2016

Related U.S. Application Data
(60) Provisional application No. 62/261,082, filed on Nov. 30, 2015.

(51) Int. Cl. G06Q 30/06; G06Q 50/22; G06Q 40/08

(52) U.S. Cl. CPC G06Q 30/0629; G06Q 40/08; G06Q 50/22

(57) ABSTRACT

Detailed resource information, including a resource preference indication, may be stored for a set of potentially available resource units. The system may store, for each resource unit, at least one performance metric score value. For each resource unit, a back-end application computer server may automatically access the performance metric score value in a resource performance metric computer store. Based on the at least one performance metric score value, the back-end application computer server may automatically update a state of the resource preference indication in an available resource computer store and automatically arrange to adjust at least one output parameter in accordance with the updated state of the resource preference indication. According to some embodiments, a diagnosis grouping platform groups similar claims handled by the panel of medical service providers, and a rating platform reviews performance of each medical service provider in the panel based on groups of similar claims.

### CROSS-REFERENCE TO RELATED APPLICATION

The present application claims the benefit of U.S. Provisional Patent Application No. 62/261,082 entitled “OUTPUT ADJUSTMENT IN ACCORDANCE WITH RESOURCE UNIT PERFORMANCE” and filed on Nov. 30, 2015. The entire content of that application is incorporated herein by reference.

### BACKGROUND

Different resource units may operate at different levels and types of performance. For example, a first resource unit might have certain characteristics that cause the resource to perform differently as compared to a second resource unit. Selection of a resource unit might, in some case, be preferably based on the performance of the resource unit. It might be difficult, however, to accurately determine the performance of a resource unit and/or to compare different resource units with each other. This might be especially true if there are a substantial number of resource units and/or the measurement of a resource unit's performance is not easily determined. Moreover, the performance of resource units may vary over time, and it can be difficult to monitor and/or compare the performances of a substantial number of resource units.

It would be desirable to provide systems and methods to adjust output information distributed via a distributed communication network by an automated back-end application computer server in a way that provides faster, more accurate results and that allows for flexibility and effectiveness when selecting and/or monitoring a resource unit.

### SUMMARY OF THE INVENTION

According to some embodiments, systems, methods, apparatus, computer program code and means are provided to adjust output information distributed via a distributed communication network by an automated back-end application computer server. Mediums, apparatus, computer program code, and means may be provided to store, for each of a plurality of potentially available resource units, detailed resource information including a resource preference indication. Moreover, the system may store, for each of the plurality of potentially available resource units, at least one performance metric score value. For each of the plurality of potentially available resource units, a back-end application computer server may automatically access the at least one performance metric score value in a resource performance metric computer store. Based on the at least one performance metric score value, the back-end application computer server may automatically update a state of the resource preference indication in an available resource computer store and automatically arrange to adjust at least one output parameter in accordance with the updated state of the resource preference indication. According to some embodiments, a diagnosis grouping platform groups similar claims handled by the panel of medical service providers (and potentially other medical service providers), and a rating platform reviews performance of each medical service provider in the panel based on groups of similar claims.

Some embodiments comprise: means for storing, for each of a plurality of potentially available resource units, detailed resource information including a resource preference indication; means for storing, for each of the plurality of potentially available resource units, at least one performance metric score value; for each of the plurality of potentially available resource units, means for automatically accessing, by the back-end application computer server, the at least one performance metric score value in a resource performance metric computer store, wherein the performance metric score value represents at least one of a magnitude of resource provided and a length of time during which resource is provided; based on the at least one performance metric score value, means for automatically updating, by the back-end application computer server, a state of the resource preference indication in an available resource computer store; and means for automatically arranging to adjust, by the back-end application computer server, at least one output parameter in accordance with the updated state of the resource preference indication. Some embodiments may include means for grouping similar claims handled by a panel of medical service providers and/or means for reviewing performance of medical service providers based on groups of similar claims.

In some embodiments, a communication device associated with a back-end application computer server exchanges information with remote devices. The information may be exchanged, for example, via public and/or proprietary communication networks.

A technical effect of some embodiments of the invention are improved and computerized ways to provide systems and methods to adjust output information distributed via a distributed communication network by an automated back-end application computer server in a way that provides faster, more accurate results and that allows for flexibility and effectiveness when selecting and/or monitoring a resource unit. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is block diagram of a system in accordance with some embodiments of the present invention.

FIGS. 4 and 5 illustrate exemplary search result displays that might be associated with various embodiments described herein.

FIG. 6 illustrates location based right to direct rules in accordance with some embodiments.

FIG. 7 is an example of a provider panel determined based on location information according to some embodiments.

FIG. 8 illustrates an update to a medical service provider panel in accordance with some embodiments.

FIG. 9 is a block diagram of an apparatus in accordance with some embodiments of the present invention.

FIG. 10 is a portion of a tabular database storing adjusted output parameters in accordance with some embodiments.

FIG. 11 illustrates a system having a predictive model in accordance with some embodiments.

FIG. 12 illustrates a tablet computer displaying adjusted output parameters according to some embodiments.

FIG. 13 is an example of an architecture in accordance with some embodiments.

FIG. 14 shows an example method according to some embodiments.

FIG. 15 shows an example graph including a function that may be used to normalize data in accordance with some embodiments.

FIG. 16 shows second example graph including a function that may be used to normalize data in accordance with some embodiments.

FIG. 17 is an example user interface element that may be used to display data that describes the composition of a panel or network of service providers according to some embodiments.

FIG. 18 illustrates a set of service providers in accordance with some embodiments.

FIG. 19 provides examples of assessment methodologies according to some embodiments.

FIG. 20 is an information flow diagram illustrating a provider outcome methodology in accordance with some embodiments.

FIG. 21 illustrates predictor variables, source systems, and text mined characteristics according to some embodiments.

FIG. 22 illustrates an outlier engine with a normative area, areas of interest, and an outlier in accordance with some embodiments.

FIG. 23 is a system block diagram of a performance monitoring system according to some embodiments.

### DETAILED DESCRIPTION

The present invention provides significant technical improvements to facilitate dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of adjusting output parameters by providing technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be transmitted from remote devices to a back-end application server and then analyzed accurately to improve the overall performance of the system (e.g., by monitoring system performance and re-allocating or re-categorizing resource units as appropriate based on metrics).

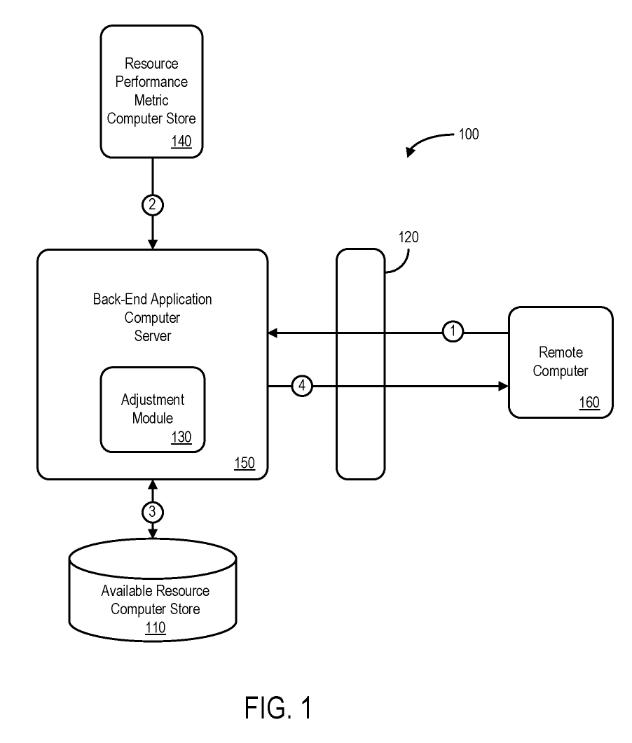

Note that, in a computer system, different resource units may operate at different levels and types of performance. For example, a first resource unit might have certain characteristics that cause the resource to perform differently as compared to a second resource unit. Selection of a resource unit might, in some case, be preferably based on the performance of the resource unit. It might be difficult, however, to accurately determine the performance of a resource unit and/or to compare different resource units with each other. This might be especially true if there are a substantial number of resource units and/or the measurement of a resource unit's performance is not easily determined. It would be desirable to provide systems and methods to adjust output information distributed via a distributed communication network by an automated back-end application computer server in a way that provides faster, more accurate results and that allows for flexibility and effectiveness when selecting a resource unit. FIG. 1 is block diagram of a system 100 according to some embodiments of the present invention. In particular, the system 100 includes a back-end application computer server 150 that may access information in an available resource computer store 110. The back-end application computer server 150 may also exchange information with a remote computer 160 (e.g., via a firewall 120) and/or resource performance metric computer store 140. According to some embodiments, an adjustment module 130 of the back-end application computer server 150 may facilitate the adjustment of parameters transmitted to one or more remote computers 160.

The back-end application computer server 150 might be, for example, associated with a Personal Computer (“PC”), laptop computer, smartphone, an enterprise server, a server farm, and/or a database or similar storage devices. According to some embodiments, an “automated” back-end application computer server 150 may facilitate the adjustment of parameters, such as parameters in the available resource computer store 110. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the available resource computer store 110. The available resource computer store 110 might, for example, store data associated with a set of potentially available resource units. The available resource computer store 110 may contain, for example, detailed resource information including a resource preference indication, a resource name, a resource communication address, etc. The available resource computer store 110 may be locally stored or reside remote from the back-end application computer server 150. As will be described further below, the available resource computer store 110 may be used by the back-end application computer server 150 to adjust or otherwise modify parameters that will be transmitted to the remote computer 160. Although a single back-end application computer server 150 is shown in FIG. 1, any number of such devices may be included. Moreover, various devices described herein might be combined according to embodiments of the present invention. For example, in some embodiments, the back-end application computer server 150 and available resource computer store 110 might be co-located and/or may comprise a single apparatus.

According to some embodiments, the system 100 may utilize resource performance metric values received over a distributed communication network via the automated back-end application computer server 150. For example, at (1) the remote computer 160 may request that a list of resource units be displayed. The back-end application computer server 150 may then retrieve information from the resource performance metric computer store 140 at (2). This information may then be used to adjust one or more parameters associated with the available resource computer store 110 at (3). For example, the adjustment module 130 may be executed causing an adjusted list of resource units to be transmitted to the remote computer 160 at (4) (e.g., units in the list might be suppressed or re-ordered based on the information from the resource performance metric computer store 140).

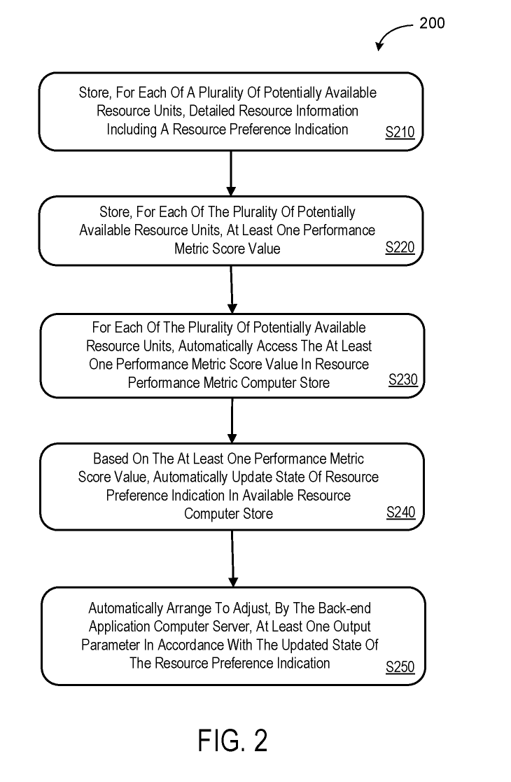

Note that the system 100 of FIG. 1 is provided only as an example, and embodiments may be associated with additional elements or components. According to some embodiments, the elements of the system 100 adjust parameters being transmitted via a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may store, in an available resource computer store for each of a plurality of potentially available resource units, detailed resource information including a resource preference indication. The resource preference indication may, for example, indicate that a resource unit is considered preferable by the system to at least some other resource units.

At S220, a resource performance metric computer store may store for each of the plurality of potentially available resource units, at least one performance metric score value.

At S230, the system may, for each of the plurality of potentially available resource units, automatically access the at least one performance metric score value in the resource performance metric computer store. The performance metric score value may represent, for example, a magnitude of resource provided and/or a length of time during which resource is provided.

At S240, based on the at least one performance metric score value, the system may automatically update a state of the resource preference indication in the available resource computer store.

Note that there may be a large variation of potential outcomes with respect to performance metrics (e.g., tied to different treatment paths). At S250, the system may automatically arrange to adjust at least one output parameter in accordance with the updated state of the resource preference indication. For example, a non-preferred resource unit might be removed from a list of search results or be moved to a lower location within the list. In this way, the system may act as an optimization and selection tool to pair an injured worker with the best possible medical service provider for that particular worker. Embodiments may evaluate weight, distance, cost, quality, patient comorbidities, patient demographic variables, provider satisfaction ratings, and/or clinical outcome data to match a claimant with a particularly suitable medical service provider. Note that some linkages might not be immediately recognized (e.g., a divorced worker may get better results from a particular service provider), but may instead be uncovered by machine analysis and learning algorithms.

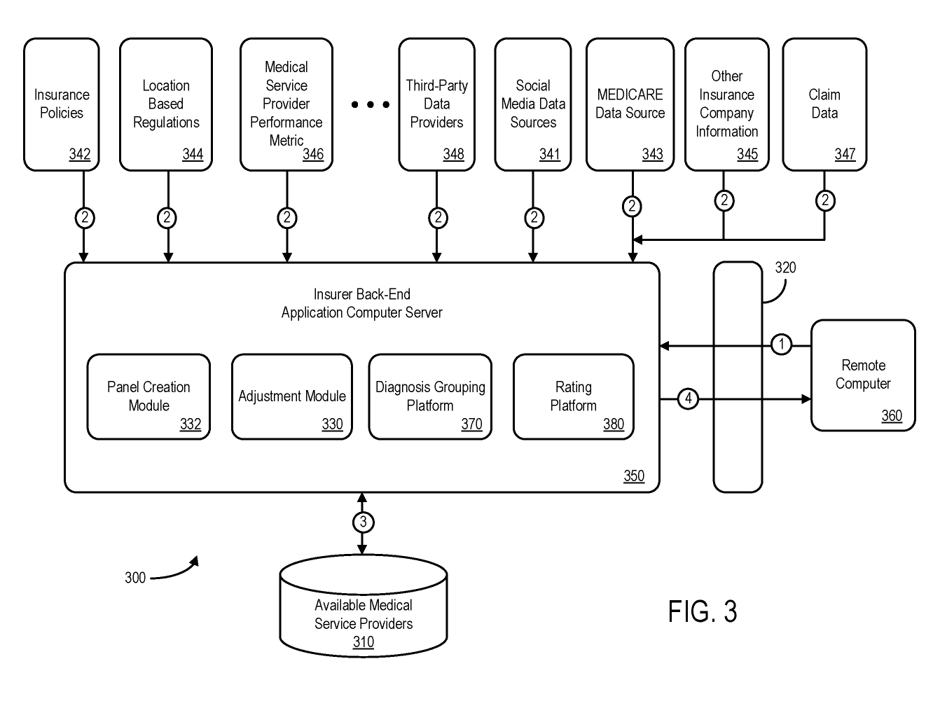

Some of the embodiments described herein may be implemented via an insurance enterprise system. For example, FIG. 3 is block diagram of a system 300 according to some embodiments of the present invention. As in FIG. 1, the system 300 includes a back-end application computer server 350 that may access information in database of available medical service providers 310. The back-end application computer server 350 may also exchange information with a remote computer 360 (e.g., via a firewall 320), and/or information sources 342, 344, 346, 348. According to some embodiments, a panel creation module 332 and an adjustment module 330 of the back-end application computer server 350 facilitates the transmission of risk information to the remote computer 360. The back-end application computer server 350 may also contain, according to some embodiments, a diagnosis grouping platform 370 (to group similar claims handled by a set of medical service providers as described herein) and/or a rating platform 380 (e.g., an outlier identifier to recognize medical service providers with anomalous outcomes, a volatility detector as described herein, etc.).

The back-end application computer server 350 might be, for example, associated with a PC, laptop computer, smartphone, an enterprise server, a server farm, and/or a database or similar storage devices. The back-end application computer server 350 may store information into and/or retrieve information from the database of available medical service providers 310. The database of available medical service providers 310 might, for example, store data associated with past and current insurance policies. The database of available medical service providers 310 may be locally stored or reside remote from the back-end application computer server 350. As will be described further below, the database of available medical service providers 310 may be used by the back-end application computer server 350 to adjust information provided to the remote computer 360.

According to some embodiments, the system 300 may evaluate performance information over a distributed communication network via the automated back-end application computer server 350. For example, at (1) the remote computer 360 may request a list of medical service providers that meet a pre-determined criteria (e.g., that are located near a particular ZIP code). The back-end application computer server may then analyze data from in the information sources 342, 344, 346, 348 at (2). In particular, the data might include information about insurance policies 342 (e.g., policies associated with workers' compensation insurance, automobile insurance, short term disability insurance, and/or long term disability insurance), location based regulations 344, one or more medical service provider performance metrics 346, third-party data providers 348, etc. Other examples of data that might be utilized include social media data sources 341 (including review sites), MEDICARE or other governmental data sources 343, information gathered from other insurance companies 345 (e.g., data from health care networks), and/or claim data (e.g., including a claim's associated medical cost, length of disability, etc.). Note that any of the data sources might utilize text mining, natural language processing, speech-to-text conversion, etc.

Note that the medical service provider performance metric 346 might be associated with an average claimant satisfaction, an average claim adjuster satisfaction, an average employer satisfaction, a frequency of surgery (e.g., in view of the diagnosis of a particular worker), physician medication prescribing patterns, quantity and frequency of physical therapy, an average amount of lost time from work, a death rate, a bad outcome rate, colleague recommendations, credential verification, a quality of an associated hospital (which might, for example, let an insurer leverage data based on hospital information), a medical cost, a length of disability, and/or an amount of deviation from standards based medicine and adherence to guidelines. Moreover, a performance metric score might be associated with an internal physician dispensing score, an internal physician outlier score, an internal utilization review, an external healthcare dataset, an external Medicare dataset, and/or a vender dataset.

At (3), the system may access information in the database of available medical service providers 310. When the back-end application computer server 350 is associated with an insurer, the database of available medical service providers 310 may contain, for each of a plurality of potentially available medical service providers, detailed resource information such as a potentially available medical service provider name, a potentially available medical service provider address, a potentially available medical service provider communication address (e.g., a telephone number or email address), a potentially available medical service provider specialty, a potentially available medical service provider language, and/or potentially available medical service provider insurance information. Note that the detailed resource information might further include how long a patient spends at the treatment facility, how long he or she usually needs to wait for an appointment, whether or not patient records are accurately kept, whether or not electronic health records are utilized, etc.

At (4), adjustment module 330 will arrange to use the data from one or more of the information sources 341, 342, 343, 344, 345, 346, 347, 348 to adjust a presentation of at least one output parameter to the remote computer 360. This arranging may be, for example performed on a periodic basis (e.g., a daily, weekly, monthly, or yearly basis). According to some embodiments, this adjustment to the at least one output parameter is associated with creation of a panel of medical service providers by the panel creation module 330 (e.g., a panel of doctors who may treat an injured worker). Note that the creation of the panel of medical service providers might be based at least in part on a geographic location associated with an insurance claim (e.g., different states might have different laws and/or regulations that limit how a panel might be created). For example, in some states the creation of the panel of medical service providers might be performed prior to receipt of an insurance claim while in other states the creation of the panel of medical service providers is performed responsive to receipt of an insurance claim. Such an approach might also be used, according to some embodiments, to route claimants with highly variable outcomes to various intervention and/or second opinion programs.

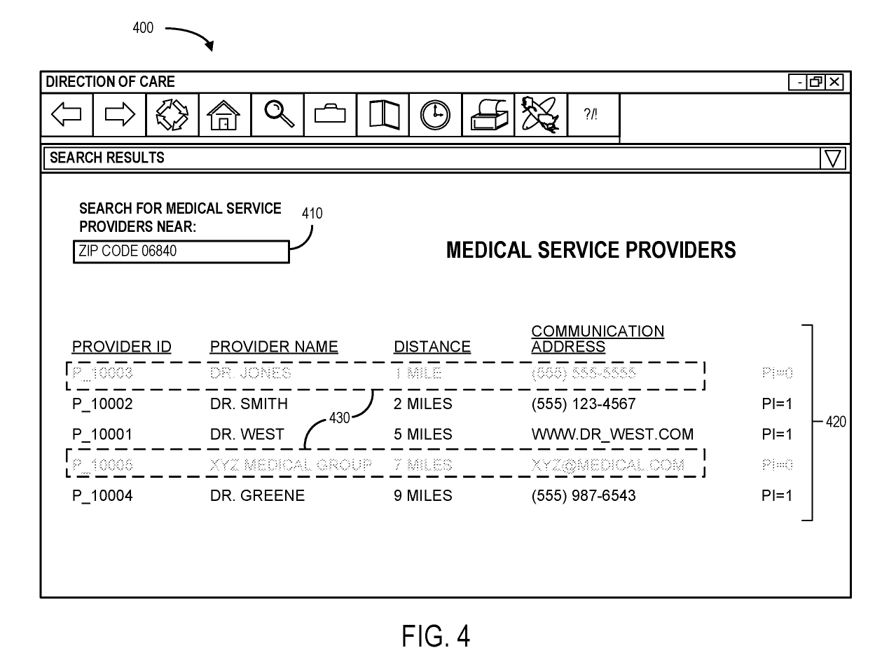

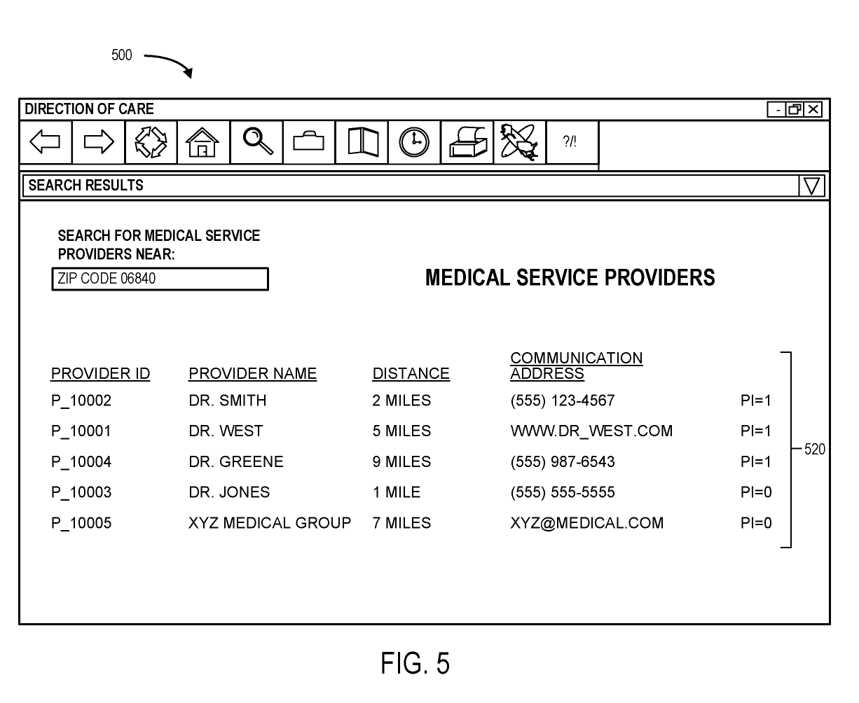

According to some embodiments, the adjustment module 330 alters a list of search results provided to the remote computer 360 at (4). Consider, for example, FIG. 4 which illustrates an exemplary search result display 400 that might be associated with various embodiments described herein. In this example, a user has entered a ZIP code 410 and asked for a list of nearby available medical service providers. Moreover, a list of available medical service providers 420 has been displayed to the user. In this example, the list 420 is ordered by distance from the ZIP code. Note that each provider in the list 420 has an associated Preference Indication (“PI”) score with “0” indicating not preferred and “1” indicating preferred. Although the PI scores are shown in FIG. 4 for clarity, the list that is actually displayed to the user might not include the scores. A PI score of “0” might indicate, for example, that a service provider is frequently associated with bad outcomes, poor customer service scores, lengthy absences from the workplace, etc. According to this embodiment, service providers with a PI score of “0” are deleted from the list (as illustrated by the grey text 430) and will not be seen by the user at all. According to another embodiment, illustrated by the display 500 of FIG. 5, service providers with a score of “0” are instead moved to lower locations in the search result list 520 (e.g., despite the fact that they are located closer to the user's ZIP code).

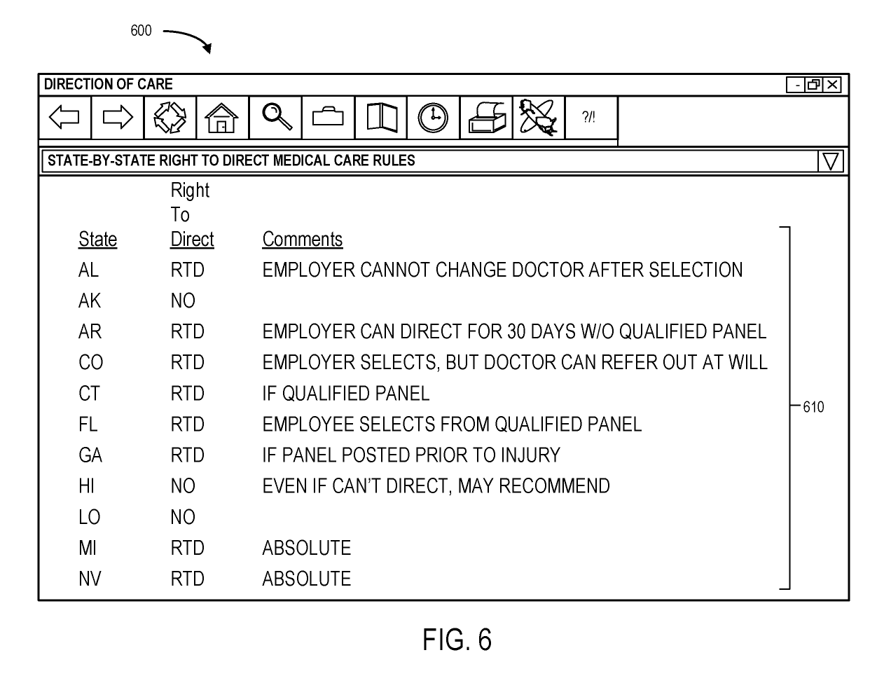

Such an approach may make it more likely that users will select service providers that have a preferred PI score. In some situations, an insurer may have a “Right To Direct” (“RTD”) an insured to a set of service providers. For example, in some states an insurer may provide a set of pre-approved medical service providers to an injured worker who may then select to receive care from a provider on that list. FIG. 6 illustrates display 600 including location based RTD rules 610 in accordance with some embodiments. In some states, an insurer might not have a RTD an injured party to a set of medical service providers (e.g., New York and Connecticut as illustrated in FIG. 6), in other states an insurer might be allowed to define and publicly post a panel of approved medical service providers prior to an occurrence of an injury (e.g., Georgia as illustrated in FIG. 6, in which case the system might periodically generate such panels), while in still other states an insurer might be allowed to define a panel of approved medical service providers after an injury occurs (e.g., Virginia), in which case the system might define a panel in response to a submitted claim. Note that even in states where an insurance company does not have a right to direct care, it might still provide recommendations (e.g., as illustrated by Hawaii in FIG. 6), provide a detailed explanation as to why such recommendations are being made, and/or offer educational materials to injured employees (e.g., comparing average MRI costs between providers, explaining that doctors who perform a particular type of surgery typically have worse outcomes as compared to doctors who recommend physical therapy instead, etc.). Furthermore, in certain lines of insurance like short-term and long-term disability insurance, medical care is not a covered benefit but the quality of the care greatly impacts the duration of disability. In general, the system may attempt to match each injured worker with the best possible provider for that worker (e.g., a doctor who specialized in working with smokers might be selected for an injured worker who smokes but not for other injured workers). Moreover, the system may take co-morbidity factors into account (e.g., workers who are both obese and suffer from a particular back injury might find a certain medical service provider most beneficial).

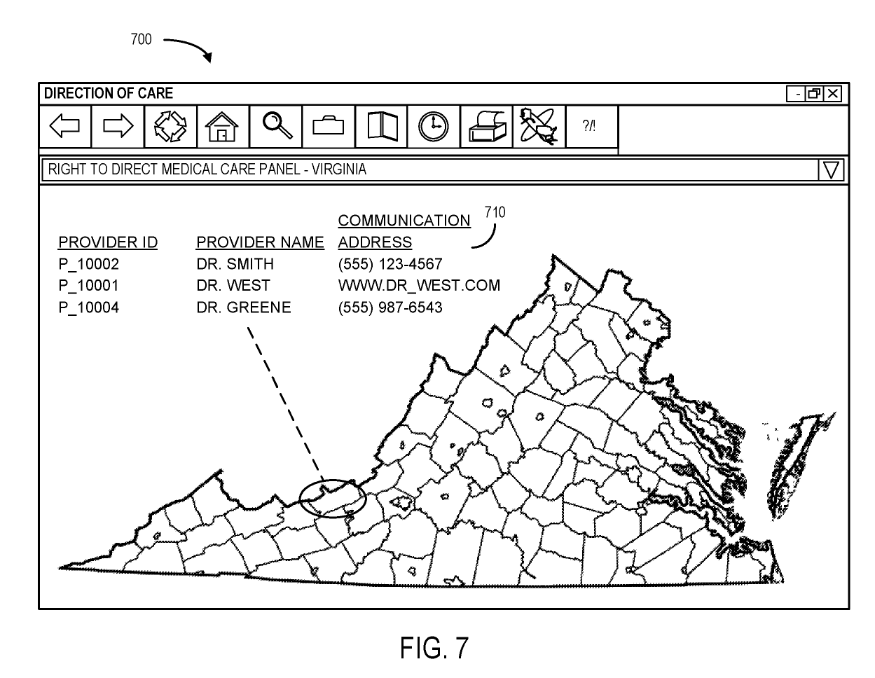

Thus, a panel of medical service providers might be generated in accordance with a state's rules and regulations. Moreover, a panel might be created based at least in part on the location of the providers within a state. For example, FIG. 7 is an example of a display 700 including a provider panel 710 determined based on location information according to some embodiments. The panel 710 might include, for example, for each provider with a PI score of “1”: a provider ID, a provider name, and a communication address for the provider (e.g., a postal address, telephone number, web site, etc.).

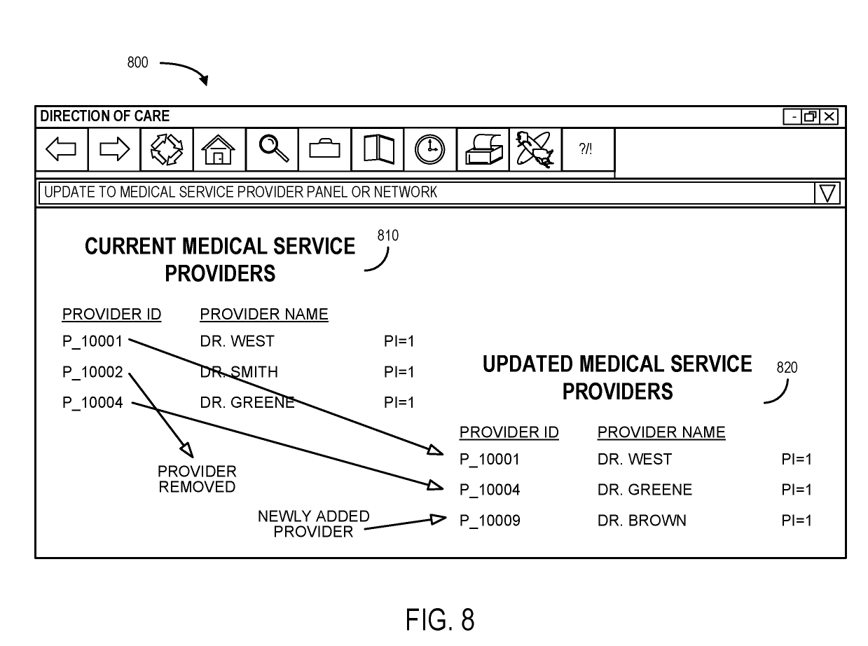

In addition to, or instead of, using a PI score, the system may select medical service providers using any other type of performance metric. For example, FIG. 8 illustrates a display including a current panel of approved medical service providers 810, all of which have a PI score of “1.” In this example, however, the provider with the lowest performance metric (e.g., patient satisfaction score, length of absence from work, etc.) is automatically removed from the panel on a periodic basis and replaced with another provider. As illustrated by the updated medical service provider panel 820 in FIG. 8, provider ID “P_10002” has been removed and replaced with newly added provider ID “P_10009.” According to some embodiments, such an approach may involve an evolutionary model and/or algorithm that replaces service providers over time (and which may or may not have a manual override allowing an administrator to block or add providers).

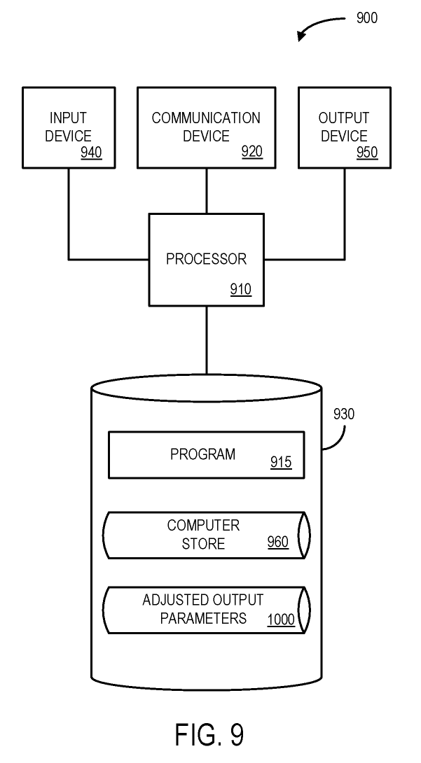

The embodiments described herein may be implemented using any number of different hardware configurations. For example, FIG. 9 illustrates a back-end application computer server 900 that may be, for example, associated with the systems 100, 300 of FIGS. 1 and 3, respectively. The back-end application computer server 900 comprises a processor 910, such as one or more commercially available Central Processing Units (“CPUs”) in the form of one-chip microprocessors, coupled to a communication device 920 configured to communicate via a communication network (not shown in FIG. 9). The communication device 920 may be used to communicate, for example, with one or more remote computers. Note that communications exchanged via the communication device 920 may utilize security features, such as those between a public internet user and an internal network of the insurance enterprise. The security features might be associated with, for example, web servers, firewalls, and/or PCI infrastructure. The back-end application computer server 900 further includes an input device 940 (e.g., a mouse and/or keyboard to enter information about RTD rules or business logic, historic information, predictive models, etc.) and an output device 950 (e.g., to output reports regarding service providers, pre-determined panels, and/or insured parties).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 915 and/or an adjustment tool or application for controlling the processor 910. The processor 910 performs instructions of the program 915, and thereby operates in accordance with any of the embodiments described herein. For example, the processor 910 may store, for each of a plurality of potentially available resource units, detailed resource information including a resource preference indication. The processor 910 may also store, for each of the plurality of potentially available resource units, at least one performance metric score value. For each of the plurality of potentially available resource units, the processor 910 may automatically access the at least one performance metric score value in a resource performance metric computer store. Based on the at least one performance metric score value, the processor 910 may automatically update a state of the resource preference indication in an available resource computer store. The processor 910 may then automatically arrange to adjust at least one output parameter in accordance with the updated state of the resource preference indication.

The program 915 may be stored in a compressed, uncompiled and/or encrypted format. The program 915 may furthermore include other program elements, such as an operating system, a database management system, and/or device drivers used by the processor 910 to interface with peripheral devices.

As used herein, information may be “received” by or “transmitted” to, for example: (i) the back-end application computer server 900 from another device; or (ii) a software application or module within the back-end application computer server 900 from another software application, module, or any other source.

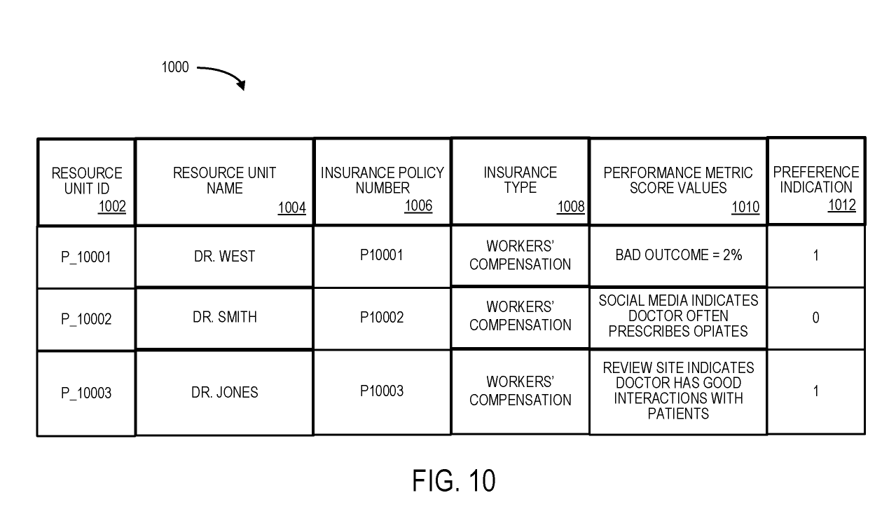

In some embodiments (such as shown in FIG. 9), the storage device 930 further stores a computer store 960 (e.g., associated with medical service providers) and an adjusted output parameters database 1000. An example of a database that might be used in connection with the back-end application computer server 900 will now be described in detail with respect to FIG. 10. Note that the database described herein is only an example, and additional and/or different information may be stored therein. Moreover, various databases might be split or combined in accordance with any of the embodiments described herein. For example, the computer store 960 and/or adjusted output parameters database 1000 might be combined and/or linked to each other within the program 915.

Referring to FIG. 10, a table is shown that represents the adjusted output parameters database 1000 that may be stored at the back-end application computer server 900 according to some embodiments. The table may include, for example, entries identifying medical service providers. The table may also define fields 1002, 1004, 1006, 1008, 1010, 1012 for each of the entries. The fields 1002, 1004, 1006, 1008, 1010, 1012 may, according to some embodiments, specify: resource unit identifier 1002, resource unit name 1004, an insurance policy number 1006, an insurance type 1008, performance metric score values 1010, and a preference indication 1012. The adjusted output parameters database 1000 may be created and updated, for example, based on information electrically received from a computer store and one or more input sources.

The resource unit identifier 1002 may be, for example, a unique alphanumeric code identifying medical service provider, and the resource unit name 1004 and the insurance policy number 1006 may be associated with an injured party. The insurance type 1008 may be used to define an type of insurance policy associated with the injured party (e.g., for workers' compensation, commercial automobile, etc.). The performance metric score values 1010 may represent, for example, patient satisfaction scores, a likelihood of a bad outcome (e.g., potentially unnecessary surgery), information determined from social media sources, governmental web pages, other insurance companies, etc. The preference indication 1012 might be a numeric value, a category (red, yellow, green), an overall ranking, etc., representing whether or not the resource unit identifier 1002 should be included in search results, be used in a medical service provider panel, etc.

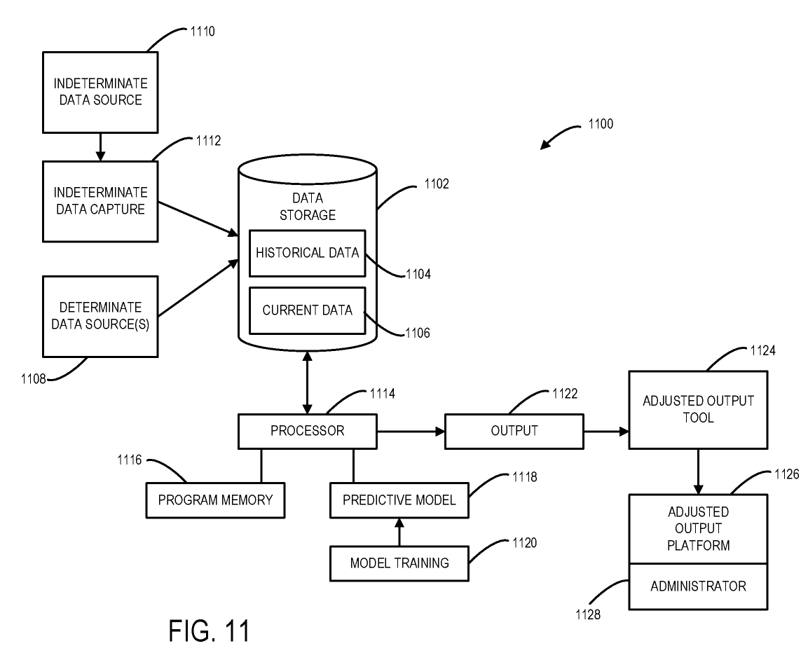

According to some embodiments, one or more predictive models may be used to select performance metric score values and/or define a preference indication (e.g., the preference indication 1012 in the adjusted output parameters database 1000). Features of some embodiments associated with a predictive model will now be described by first referring to FIG. 11. FIG. 11 is a partially functional block diagram that illustrates aspects of a computer system 1100 provided in accordance with some embodiments of the invention. For present purposes it will be assumed that the computer system 1100 is operated by an insurance company (not separately shown) for the purpose of supporting automated medical service provider information (e.g., search results and panel creation). According to some embodiments, the adjusted output parameter database 1000 may be used to supplement and leverage customer service and/or to structure various deductible arrangements.

The computer system 1100 includes a data storage module 1102. In terms of its hardware the data storage module 1102 may be conventional, and may be composed, for example, by one or more magnetic hard disk drives. A function performed by the data storage module 1102 in the computer system 1100 is to receive, store and provide access to both historical transaction data (reference numeral 1104) and current transaction data (reference numeral 1106). As described in more detail below, the historical transaction data 1104 is employed to train a predictive model to provide an output that indicates an identified performance metric and/or an algorithm to score risk factors, and the current transaction data 1106 is thereafter analyzed by the predictive model. Moreover, as time goes by, and results become known from processing current transactions, at least some of the current transactions may be used to perform further training of the predictive model. Consequently, the predictive model may thereby adapt itself to changing conditions.

Either the historical transaction data 1104 or the current transaction data 1106 might include, according to some embodiments, determinate and indeterminate data. As used herein and in the appended claims, “determinate data” refers to verifiable facts such as the an age of a home; an automobile type; a policy date or other date; a driver age; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files.

The determinate data may come from one or more determinate data sources 1108 that are included in the computer system 1100 and are coupled to the data storage module 1102. The determinate data may include “hard” data like a claimant's name, date of birth, social security number, policy number, address, an underwriter decision, etc. One possible source of the determinate data may be the insurance company's policy database (not separately indicated).

The indeterminate data may originate from one or more indeterminate data sources 1110, and may be extracted from raw files or the like by one or more indeterminate data capture modules 1112. Both the indeterminate data source(s) 1110 and the indeterminate data capture module(s) 1112 may be included in the computer system 1100 and coupled directly or indirectly to the data storage module 1102. Examples of the indeterminate data source(s) 1110 may include data storage facilities for document images, for text files, and digitized recorded voice files. Examples of the indeterminate data capture module(s) 1112 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1100 also may include a computer processor 1114. The computer processor 1114 may include one or more conventional microprocessors and may operate to execute programmed instructions to provide functionality as described herein. Among other functions, the computer processor 1114 may store and retrieve historical insurance transaction data 1104 and current transaction data 1106 in and from the data storage module 1102. Thus the computer processor 1114 may be coupled to the data storage module 1102.

The computer system 1100 may further include a program memory 1116 that is coupled to the computer processor 1114. The program memory 1116 may include one or more fixed storage devices, such as one or more hard disk drives, and one or more volatile storage devices, such as RAM devices. The program memory 1116 may be at least partially integrated with the data storage module 1102. The program memory 1116 may store one or more application programs, an operating system, device drivers, etc., all of which may contain program instruction steps for execution by the computer processor 1114.

The computer system 1100 further includes a predictive model component 1118. In certain practical embodiments of the computer system 1100, the predictive model component 1118 may effectively be implemented via the computer processor 1114, one or more application programs stored in the program memory 1116, and computer stored as a result of training operations based on the historical transaction data 1104 (and possibly also data received from a third party). In some embodiments, data arising from model training may be stored in the data storage module 1102, or in a separate computer store (not separately shown). A function of the predictive model component 1118 may be to determine appropriate performance metric scores and/or scoring algorithms. The predictive model component may be directly or indirectly coupled to the data storage module 1102.

The predictive model component 1118 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1100 includes a model training component 1120. The model training component 1120 may be coupled to the computer processor 1114 (directly or indirectly) and may have the function of training the predictive model component 1118 based on the historical transaction data 1104 and/or information about potential insureds. (As will be understood from previous discussion, the model training component 1120 may further train the predictive model component 1118 as further relevant data becomes available.) The model training component 1120 may be embodied at least in part by the computer processor 1114 and one or more application programs stored in the program memory 1116. Thus, the training of the predictive model component 1118 by the model training component 1120 may occur in accordance with program instructions stored in the program memory 1116 and executed by the computer processor 1114.

In addition, the computer system 1100 may include an output device 1122. The output device 1122 may be coupled to the computer processor 1114. A function of the output device 1122 may be to provide an output that is indicative of (as determined by the trained predictive model component 1118) particular performance metrics and/or search results. The output may be generated by the computer processor 1114 in accordance with program instructions stored in the program memory 1116 and executed by the computer processor 1114. More specifically, the output may be generated by the computer processor 1114 in response to applying the data for the current simulation to the trained predictive model component 1118. The output may, for example, be a numerical estimate and/or a likelihood within a predetermined range of numbers. In some embodiments, the output device may be implemented by a suitable program or program module executed by the computer processor 1114 in response to operation of the predictive model component 1118.

Still further, the computer system 1100 may include a adjusted output tool module 1124. The adjusted output tool module 1124 may be implemented in some embodiments by a software module executed by the computer processor 1114. The adjusted output tool module 1124 may have the function of rendering a portion of the display on the output device 1122. Thus, the adjusted output tool module 1124 may be coupled, at least functionally, to the output device 1122. In some embodiments, for example, the adjusted output tool module 1124 may direct workflow by referring, to an administrator 1128 via an adjusted output platform 1226, search results generated by the predictive model component 1118 and found to be associated with various medical service providers. In some embodiments, these results may be provided to an administrator 1128 who may also be tasked with determining whether or not the results may be improved (e.g., by having a risk mitigation team talk with a medical service provider).

Thus, embodiments may provide an automated and efficient way to select medical service providers and refined panels may align with business goals of improving quality, customer satisfaction, and/or efficiency. The direction of care to physicians that provide the best outcomes may improve an insurer's loss ratio, return injured claimants back to work sooner, and/or reduce unnecessary pain and disability associated with ineffective treatment. A process for physician selection may provide each physician in the country with an indicator that is based upon outcomes derived from using internal and external data. These indicators may be developed from a repeatable process that can be applied in all jurisdictions. Physicians with the best scores may be used for panel development in panel jurisdictions (e.g., at a county level), and claims handlers may simply look up an appropriate panel using an Excel spreadsheet application file driven by ZIP codes. In RTD care states, claimants may be directed to top performing physicians through the same county based list process or through current search channels (e.g., where the least preferred providers may be removed from the display entirely). In jurisdictions which do not permit the right to direct care, or the provision of a patent, claims adjusters may share performance metrics with a claimant as part of an educational process to aid in decision making. For short and long-term disability claims, performance rankings can be shared and coupled with cost information to help employees make the best decisions possible in light of the fact that they will often pay a significant portion of the medical costs under their healthcare plans.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

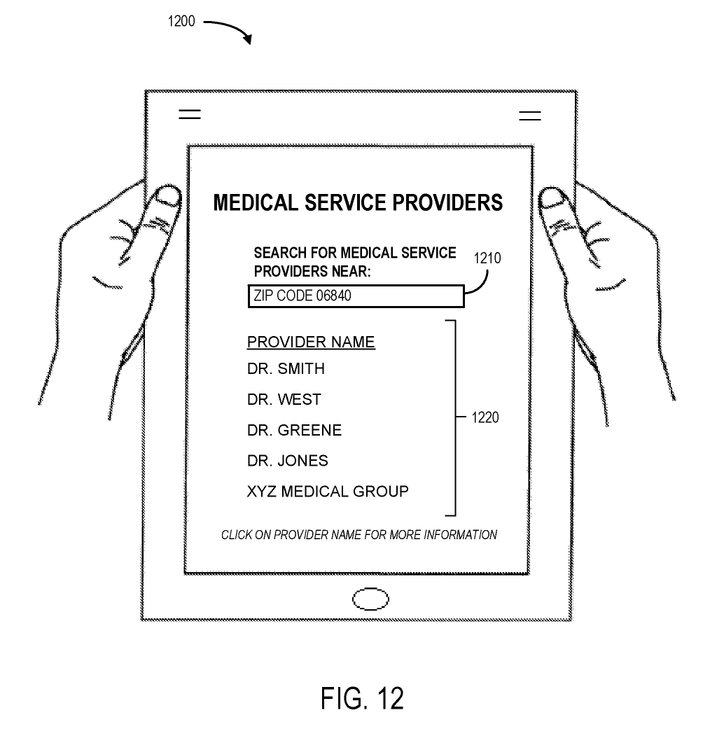

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance. Still further, the displays and devices illustrated herein are only provided as examples, and embodiments may be associated with any other types of user interfaces. For example, FIG. 12 illustrates a handheld adjusted search result display 1200 wherein entry of a ZIP code 1210 may result in display of a list medical service provider names 1220 that meet some performance metric rule (e.g., having a PI score of “1”) according to some embodiments.

Note that embodiments described herein may utilize any number of performance metric values instead of, or in addition to, the PI score. Consider, for example, workers' compensation insurance that provides benefits to workers injured in the course of employment. Benefits that may be provided as part of workers' compensation include disability benefits, rehabilitation services, and medical care. An employer may purchase a workers' compensation insurance policy from an insurance provider, and the policy may identify a network of service providers that treat the employees according to the policy. Service providers may include hospitals, doctors, and rehabilitation providers that administer care to injured workers. Service providers may vary in terms of the quality of care provided to injured workers. For example, a service provider may provide superior medical treatment versus other service providers, and workers that receive care from the superior service provider may consistently have better outcomes (i.e., may recover from injuries more quickly) than workers who are treated by other service providers. Note that in some embodiments, other considerations may be taken into account along with treatment quality. Moreover, according to some embodiments, a certification associated with specialized training (including training or educational materials provided by an insurer) might be used to help select an appropriate service provider to be assigned to a claim.

To provide the best care possible to injured workers, insurance providers and employers want the best possible service providers to be included in a RTD panel and/or a service provider network. However, it may be difficult for insurance providers and employers to determine who the best service providers are. Therefore, new technologies are required that may be used to assess the effectiveness of service providers, such that the best possible care may be provided to injured workers. According to any of the embodiments described herein, such an assessment might be based at least in part on a magnitude of resource provided (e.g., representing a medical cost) and/or a length of time during which resource is provided (e.g., representing a length of disability).

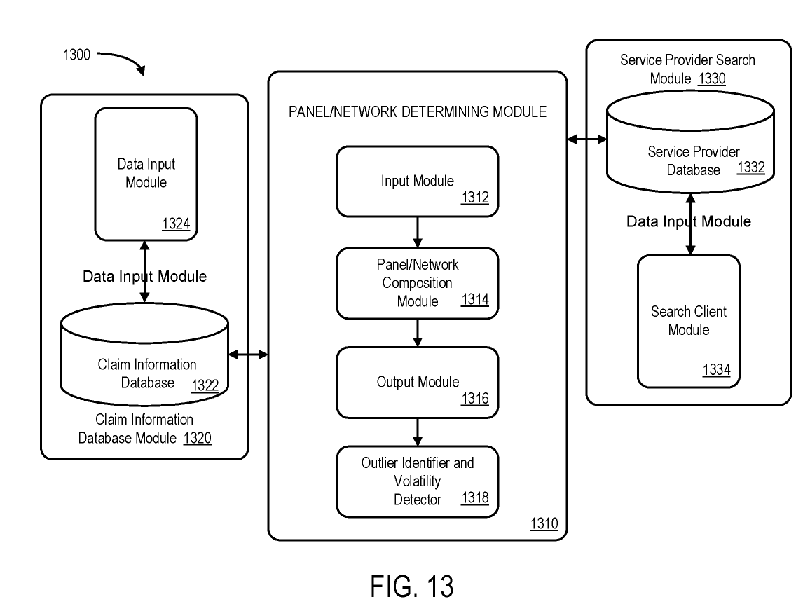

FIG. 13 shows an example architecture 1300 for determining the composition of a service provider panel or network for use in the context of workers' compensation insurance. As will be described in further detail below, the example architecture 1300 of FIG. 13 may be used to determine if specific service providers should be included in a service provider panel, search result, or network, and/or to determine how service providers within a network should be ranked or classified.

The example architecture 1300 includes a panel/network determining module 1310, which is configured to analyze data and determine the composition of a service provider panel or network. The example architecture 1300 may also include a claim information database 1322, a claim information database module 1320, and a data input module 1324, which perform functionality related to the storage of data that describes services that have been provided to users by medical service providers. Further, the example architecture 1300 may include a service provider search module 1330, a service provider network database 1332, and a search client module 1334, which together provide data to users about medical service providers from which the users may receive services.

The claim information database 1322 may be stored on one or any number of computer-readable storage media (not depicted). The claim information database 1322 may be or include, for example, a relational database, a hierarchical database, an object-oriented database, one or more flat files, one or more spreadsheets, and/or one or more structured files. The claim information database 1322 may store information related to claims that have been filed and medical service providers that have provided services related to the claims. The claim information database 1322 may include data related to service providers who are already included in one or more service provider networks, service providers who are not currently in a service provider network, and/or any combination thereof. For each claim, the claim information database 1322 may include one or more parameters associated with the claim, such as: the amount paid by the insurance provider for the claim; the number of disability days for which the claimant missed work; whether the claim is associated with litigation or other legal activity; the number of days the claim has stayed open, which may also be referred to as the “age” or “maturity” of a claim; whether the claim settled; whether the compensability of the claim has been determined (in other words, whether a determination has been that the claim relates to an injury that should be compensated by workers' compensation insurance, or whether investigation into this topic is still ongoing); the number of service provider office visits associated with the claim; whether surgery was associated with the claim; whether inpatient hospitalization was associated with the claim; the age of the claimant; a treatment delay time (i.e., the period of time that passed between the injury and when the claimant first sought treatment for the injury); a location where the injury and/or the treatment took place; a service provider that provided services associated with the claim; and/or other information. Further, the claim information database 1322 may include information such as whether each claim involved lost time. Many jurisdictions define a waiting period that follows the onset of an injury. Work that is missed during this waiting period does not constitute lost time; however, work that is missed by an injured working after the waiting period is considered lost time. Alternatively or additionally, the claim information database 1322 may store qualitative information related to the claims, such as: data that describes the satisfaction of the claimant with the care received; data that describes the satisfaction of a claims adjuster that handled the treatment associated with the claim with the service provider; and/or information that describes the satisfaction of the claimant's employer with how the service provider handled the treatment associated with the claim. A level of satisfaction may be represented using a numeric scale, with different values along the scale corresponding to different levels of satisfaction. As an example, a scale of zero to ten may be used, wherein zero represents the lowest level of satisfaction and ten represents the highest level of satisfaction).

The claim information database module 1320 may perform functionality such as adding data to, modifying data in, querying data from, and/or retrieving data from the claim information database 1322. The claim information database module 1320 may be, for example, a Database Management System (“DBMS”), a database driver, a module that perform file input/output operations, and/or other type of module. The claim information database module 1320 may be based on a technology such as Microsoft SQL Server, Microsoft Access, MySQL, PostgreSQL, Oracle Relational Database Management System (“RDBMS”), Microsoft Excel, a NoSQL database technology, and/or any other appropriate technology. The data input module 1324 may perform functionality such as providing data to the claim information database module 1320 for storage in the claim information database 1322. The data input module 1324 may be, for example, a spreadsheet program, a database client application, a web browser, and/or any other type of application that may be used to provide data to the claim information database module 1320.

The panel/network determining module 1310 may perform functionality such as determining the composition of a service provider network based on information stored in the claim information database 1322. The network determining module 1310 may include an input module 1312, a panel/network composition module 1314, and an output module 1316. The input module 1312 may perform functionality such as obtaining data from the claim information database module 1320 and providing the data to the panel/network composition module 1344. The panel/network composition module 1314 may perform functionality such as analyzing the data provided by the input module 1312 to determine the composition of a service provider panel or network. This may include, for example, analyzing how well service providers perform in a number of parameters (such as those described above as stored in the claim information database 1322), assigning scores to the service providers based on their performances, and ranking service providers based on their scores. The panel/network composition module 1314 may determine whether or not service providers should be included in a service provider panel or network, based on the scores. Alternatively or additionally, the panel/network composition module 1314 may determine that service providers within a certain range of scores may be classified differently from service providers within other ranges. For example, service providers with scores above a threshold value should be classified as “preferred” providers within the network, while providers with lower scores may not.

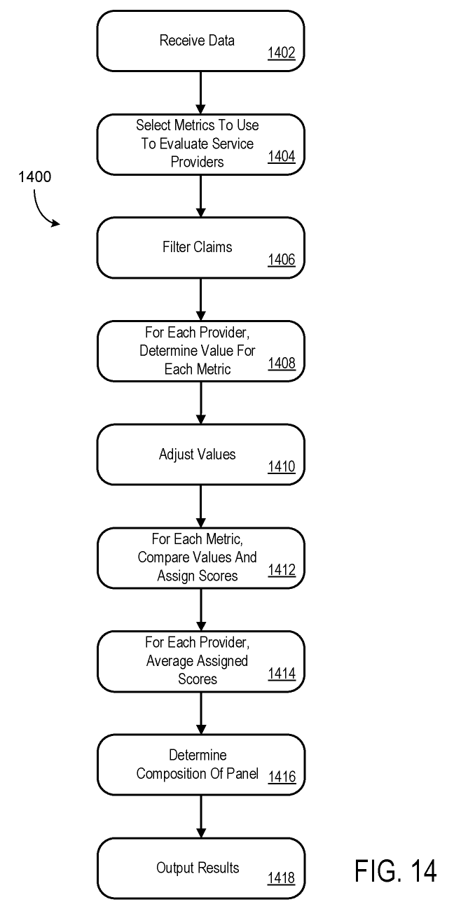

The output module 1316 may obtain results determined by the panel/network composition module 1314 and may output the results in a number of ways. For example, the output module 1316 may store the results in one or more computer-readable media (not depicted), and/or may send information related to the results to an output device (not depicted) such as a printer, display device, or network interface. Alternatively or additionally, the output module 1316 may transmit and/or otherwise output its results for storage in the service provider network database 1332. Further details regarding functionality that may be performed by the network determining module 1310 are provided below with reference to FIG. 14.

The service provider network database 1332 may store information that describes the composition of a service provider network. For example, the service provider network database 1332 may include information that identifies service providers in the network, and may include contact information, specialty information, geographic information, information regarding how well service providers have been ranked by the panel/network composition module 1314 (for example, whether providers are “preferred” or not), and/or information associated with the service providers. The service provider network database 1332 may be stored on one or any number of computer-readable storage media (not depicted). The claim information database 1322 may be or include, for example, a relational database, a hierarchical database, an object-oriented database, one or more flat files, one or more spreadsheets, and/or one or more structured files. According to some embodiments, the output module 1316 may provide information to an outlier identifier and/or a volatility detector 1318 (e.g., to facilitate identification of service providers that may require any of the various types of intervention actions described herein).

The service provider search module 1330 may provide search functionality that allows users to search for service providers whose information is stored in the service provider network database 1332. A user may interact with the service provider search module 1330 using the search client module 1334. The search client module 1334 may provide a user interface that the user may use to enter information to search for a service provider. As an example, the search client module 1334 may be a web browser or similar application.

As an example, a user may wish to search for a medical service provider for a particular medical specialty that is geographically nearby to the user's location. The user may enter these search parameters into the user provided by the search client module 1334, which may transmit the search parameters to the service provider search module 1330. The search parameters may include, for example, an area of specialization, name, geographic location (such as a state, city, and/or ZIP code), and/or other parameters. The service provider search module 1330 may then search for a service provider in the service provider database 1332 that matches the parameters, and transmit search response information to the search client module 1334. The service provider search module 1330 may generate the results based on information such as how the service providers have been ranked by the panel/network composition module 1314. For example, the service provider search module 1330 may generate results that will display preferred providers before providers with less favorable rankings are displayed. Alternatively or additionally, the service provider search module 1330 may generate the search results to include only service providers within a certain range of scores. The search client module 1334 may then display the adjusted search response information to the user via a display device (not depicted). The search response information may include contact information such as telephone numbers, addresses, and/or other information related to the medical service providers that match the search criteria. Using the contact information, the user may contact the service providers and initiate a visit to the service provider to begin medical treatment.

Each or any combination of the modules 1310, 1312, 1314, 1316, 1324, 1320, 1330, 1334 may be implemented as software modules, specific-purpose processor elements, or as combinations thereof. A suitable software module may be or include, by way of example, one or more executable programs, one or more functions, one or more method calls, one or more procedures, one or more routines or sub-routines, one or more processor-executable instructions, and/or one or more objects or other data structures.

The example architecture 1300 of FIG. 13 may be used in any number of different contexts. As one example, an insurance provider may control the data input module 1324, claim information database module 1320, claim information database 1322, and network determining module 1310. The insurance provider may use these modules 1310, 1320, 1324 to determine the composition of a service provider panel or network for use with a workers' compensation policy. The insurance provider may provide the composition of the service provider network to a third party search vendor, which may control the service provider search module 1330. The insurance provider may provide the workers' compensation policy to an employer. When employees of the employer are injured, the employees may search for medical service providers using the search client module 1334, thereby interacting with the service provider search module 1330.

As an additional example, a Third Party Administrator (“TPA”) of a self-funded workers' compensation plan may control the data input module 1324, claim information database module 1320, claim information database 1322, and network determining module 1310. The TPA may use these modules 1310, 1320, 1324 to determine the composition of a service provider network for use with the self-funded plan. The TPA and/or a third party search vendor may control the service provider search module 1330.

Further, an insurance provider or TPA may interact with service providers differently based on the results generated by the network determining module 1310. For example, in an instance where the network determining module 1310 classifies service providers, an insurance provider or TPA may perform claim management differently with service providers that are in the different classifications. For example, an insurance provider or TPA may reduce or completely remove claim management for service providers with favorable scores, while focusing additional energy and resources for claim management for providers with less favorable scores.

FIG. 14 shows an example method 1400 for determining the composition of a service provider panel or network. The method 1400 may begin with receiving data related to service providers and claims associated with services provided by the service providers (step 1402). This may include, for example, reading the data from a computer-readable storage medium and/or receiving the data via a network interface. The data may be or include the information described above with reference to FIG. 13 as stored in the claim information database 1322. Next, metrics for evaluating service providers may be selected (step 1404). The metrics may include, for example, an average number of disability days experienced by workers that were treated by a service provider, or a percentage of claims that involved lost time. As further examples, the metrics will be established for each injury type and may include: an average paid loss per claim; a percentage of claims that are associated with legal and/or litigation activity; an average claim duration; a percentage of claims that are open after a particular duration that varies by diagnosis (e.g. spinal stenosis claims with a duration greater than 6 weeks); a percentage of claims for which compensability has not yet been determined; a percentage of claims that were settled; an average number of provider office visits for claims; a percentage of claims that involve surgery; a percentage of claims that involve inpatient hospitalization; an average number of lost work days per claim; average levels of satisfaction with provided services, as indicated by claimants, claims adjusters, and/or employers; and/or other metrics. While a number of example metrics are described above in terms of averages, the metrics may also include metrics that are based on other statistical functions such as means, modes, correlations, regressions, or standard deviations.

Claims may then be filtered, based on a number of different parameters. (step 1406). This may include removing data related to claims that have parameters that are far above or below the average for that parameter. For example, claims related to catastrophic injuries may have much higher associated costs, disability days, and/or higher values for other parameters, and data associated with these claims may be removed. As one example, claims that involved payment of more than a given threshold for a given type of expense within a given period of time may be removed. For example, claims that involved payment of more than $150,000 in medical expenses within the first six months of the filing of the claim may be removed. Alternatively or additionally, claims that involved a low total payment may be removed. For example, claims that involved a total payment of less than $50,000 may be filtered out of the received data. Alternatively or additionally, filtering may include removing data that is outside of a particular geographic area of interest. For example, if a particular ZIP code, state, or other geographic area is the region of interest, then claims that do not pertain to the geographic area may be removed.

Then, for each metric, values may be determined for each of the service providers, based on the received data (step 1408). This may include averaging and/or determining percentages for the data from the received data that is associated with claims handled by the service providers. For example, if a selected metric is an average satisfaction level for claimants, then the claimant satisfaction level values will be averaged for each service provider. Corresponding processing may be performed for each of the selected metrics.

The metric values may then be adjusted to obtain metric values that are consistent values across service providers (step 1410). Adjusting the metric values may include scaling and/or otherwise modifying the metric values, and may be based on a number of different factors. For example, metric values may be adjusted based on one or more adjustment parameters, such as the types of injuries a service provider has treated, the ages of claimants handled by a service provider, and/or the ages of claims handled by a service provider.

To adjust metric values based on the type of injuries a service provider has treated (step 1410), the following approach may be employed. First, claims may be grouped according to the type of injury, also referred to as the Major Diagnostic Category (“MDC”) of the injury. Then, for each MDC, an average metric value for claims associated with that MDC may be determined. Then, the average metric values for each MDC may be compared, and values (“scaling factors”) may be determined for each of the MDCs. Scaling factors are values that may be used to multiply the average metric values to bring the average metric values onto a common scale. Finally, metric values may be multiplied by the scaling factors to obtain adjusted metric values.

The following is an example of how metric values may be adjusted based on MDCs: A set of claims may relate to three example MDCs, “Injury One,” “Injury Two,” and “Injury Three.” The average paid loss for all claims for Injury One may be $5,000; the average paid loss for all claims for Injury Two may be $10,000; and the average paid loss for all claims for Injury Three may be $20,000. According to this example, the average paid loss is two times greater for Injury Three than for Injury Two, and four times greater for Injury Three than for Injury One. Therefore, all paid loss values for claims that are associated with Injury One may be adjusted by being multiplied by a scaling factor of four, and all paid loss values for claims that are associated with Injury Two may be adjusted by being multiplied by a scaling factor of two. By multiplying these paid loss values with these scaling factors, the average paid loss across all three of the MDCs will be the same and paid loss values across the different MDCs may be compared on a normalized scale.

To adjust metric values based on the ages of claimants handled by a service provider (step 1410), the following approach may be employed. Claims may be grouped according to the age of the claimants. Then, for each group, an average metric value for claims associated with the age may be determined. Then, a function may be derived from the averages. The function may take a claimant age range as an input, and generate a corresponding average metric value (such as, for example, an average number of disability days) as an output. Metric values may then be compared against values generated by the function, and be adjusted based on the difference between the metric values and the corresponding values generated by the function.

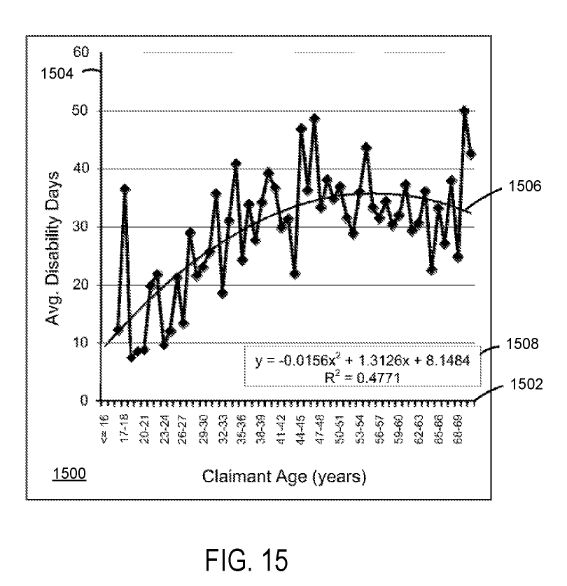

Referring now to both FIG. 14 and FIG. 15, FIG. 15 shows an example graph 1500 that shows an example function 1508 that may be used to adjust metric values based on the ages of claimants handled by a service provider (step 1410). The graph 1500 includes an X axis 1502, which corresponds to claimant ages, and a Y axis 1504, which corresponds to an average number of disability days. The graph 1500 also includes a curve 1506, which is a graphical representation of the function 1508. The curve 1506, as shown in FIG. 15, shows correspondences between claimant age ranges (on the X axis 1502) and average disability days (on the Y axis 1504).

Referring again to FIG. 14, to adjust metric values based on the ages of claims handled by a service provider (step 1410), the following approach may be employed. Claims may be grouped according to the age (in months, or some other unit of time) of the claim. Then, for each group, an average metric value for claims associated with the age. Then, a function may be derived from the averages. The function may take a claim age as an input, and generate a corresponding average metric value (such as, for example, an average disability days) as an output. Metric values may then be compared against values generated by the function, and be adjusted based on the difference between the metric values and the corresponding values generated by the function.

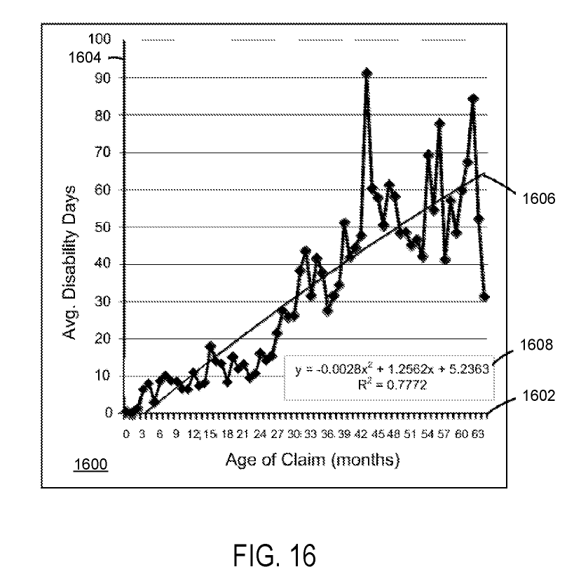

Referring now to both FIG. 14 and FIG. 16, FIG. 16 shows an example graph 1600 that shows an example function 1608 that may be used to adjust metric values based on the ages of claims handled by a service provider (step 1410). The graph 1600 includes an X axis 1602, which corresponds to claim age ranges, and a Y axis 1604, which corresponds to an average number of disability days. The graph 1600 also includes a curve 1606, which is a graphical representation of the function 1608. The curve 1606, as shown in FIG. 16, shows correspondences between claim age ranges (on the X axis 1602) and average disability days (on the Y axis 1604).

Referring again to FIG. 14, after the metric values are adjusted (step 1410), the adjusted metric values may be compared, and scores may be assigned to service providers based on the comparisons (step 1412). Here, adjusted metric values for each metric may be sorted into ascending or descending order, and percentage range distributions for the sorted values may be determined. The following table (Table I) shows examples of percentage range distributions for a number of example metrics:

TABLE I

| | Top 10% | Top 25% | Top 50% | Top 75% | Top 90% |
|---|---|---|---|---|---|
| Average | 7 | 5 | 3 | 2 | 1 |
| claimant | | | | | |
| satisfaction | | | | | |
| Average | 14 | 30 | 53 | 90 | 115 |
| disability | | | | | |
| days | | | | | |
| Average | $2,000 | $5,000 | $15,000 | $30,000 | $40,000 |
| paid loss | | | | | |

In the example of Table I, the metrics that are used are average claimant satisfaction, average disability days, and average paid loss. For average claimant satisfaction, values may be defined according to a scale of zero to ten, wherein zero represents the lowest level of satisfaction and ten represents the highest level of satisfaction. Table I is organized such that percentage ranges for qualitatively better values are on the left size of the table (e.g., a higher claimant satisfaction value is considered better than a lower claimant satisfaction value), while percentage ranges for qualitatively lesser values are on the right side of the table.

Table I shows border values for the different percentage ranges for each of the average claimant satisfaction, average disability days, and average paid loss metrics. According to the example of Table 13, the top 10% of claimant satisfaction values were at seven or above; the next 15% of claimant satisfaction values were from five to six; the next 25% of values were from three to four; the next 25% of values were from one to two; and the next 15% of values were one. Similarly, the top 10% of values for the average number of disability days were less than fourteen; in the next percentage ranges for this metric, the average numbers of disability days were less than 30, 55, 90, and 155, respectively. Further, the top 10% of values for average paid loss were less than $2,000; in the next percentage ranges for this metric, the values for average paid loss were less than $5,000, $15,000, $30,000, and $40,000, respectively. After percentage range distributions are determined, each service provider may be assigned a score for each metric, based on which percentage range the service provider falls within for that metric. The following table (Table II) shows example values that may be assigned based on percentage distributions:

TABLE II

| Percentage Range for Metric | Value to be Assigned |
|---|---|
| Top 90%-100% | 5 |
| 75%-90% | 4 |
| 50%-75% | 3 |
| 25%-50% | 2 |
| 10%-25% | 1 |
| 0%-10% | 0 |

As a further example that uses the examples of Table I and Table II, a service provider may have the following values: an average claimant satisfaction value of seven; an average disability days value of fifty; and an average paid loss value of $35,000. For average claimant satisfaction, this service provider would fall within the top 90%-100% range, and so would be assigned a value of five; for average disability days, this service provider would fall within the 50%-75% range, and so would be assigned a value of three; and for average paid loss, this service provider would fall within the 10%-25% range, and so would be assigned a value of two. In summary, the service provider would be assigned the following scores: {5, 3, 1}.

As shown in the above example, favorable percentage ranges correspond to higher values (e.g., the top 90%-100% range is associated with a value of five, the 75%-90% range is associated with a value of four, and so on.) In a variation on the above example, favorable percentage ranges may correspond to lower values and less favorable percentage ranges may correspond to higher values. According to this variation, the top 90%-100% range may correspond to a value of zero, the 75%-90% range may correspond to a value of one, the 50%-75% range may correspond to a value of three, and so on. Final scores for each service provider may then be determined by averaging the metric scores assigned to each service provider (step 1414). Referring again to the above example, the service provider was assigned the following scores: {5, 3, 1}. Averaging these scores would result in a final score for the service provider of three. Alternatively or additionally, the final scores may be a weighted average.

Then, the composition of the medical service provider panel network may be determined based on the final service provider scores (step 1416). This may include, for example, determining that service providers with a final score below a threshold are not included in the service provider panel, network, or search results, and that service providers with a final score above the threshold are included in the service provider pane, network, or search results. As one example, a value of three may be used for the threshold; according to this example, service providers with a final score of three or above may be included in a service provider panel or network, while those with a final score of one or two are not included in the service provider panel or network. Alternatively or additionally, service providers within a certain range of scores may be classified differently from service providers within other ranges. For example, service providers with a final score above a threshold value may be considered to be “preferred” providers within a panel or network, while providers with final scores below the threshold may be considered part of the panel or network, but may not be designated with a preferred status. In a variation on the above, lower final scores may be considered better than higher local scores; in such an instance, determining the composition of the service provider panel or network may include, as an example, determining that service providers with a final score above a threshold are not included in the service provider panel network and that service providers with a final score below the threshold are included in the service provider panel or network.

Once the composition of the service provider panel or network is determined, the composition and/or other related information may then be output (step 1418). This may include, for example, storing the results in one or more computer-readable media, displaying the results on a display device, printing the results via a printer, and/or communicating the results via a network interface. The other related information that may also be output may include any of the data or other parameter described above as used during steps 1402 through 1416, and/or other parameters.

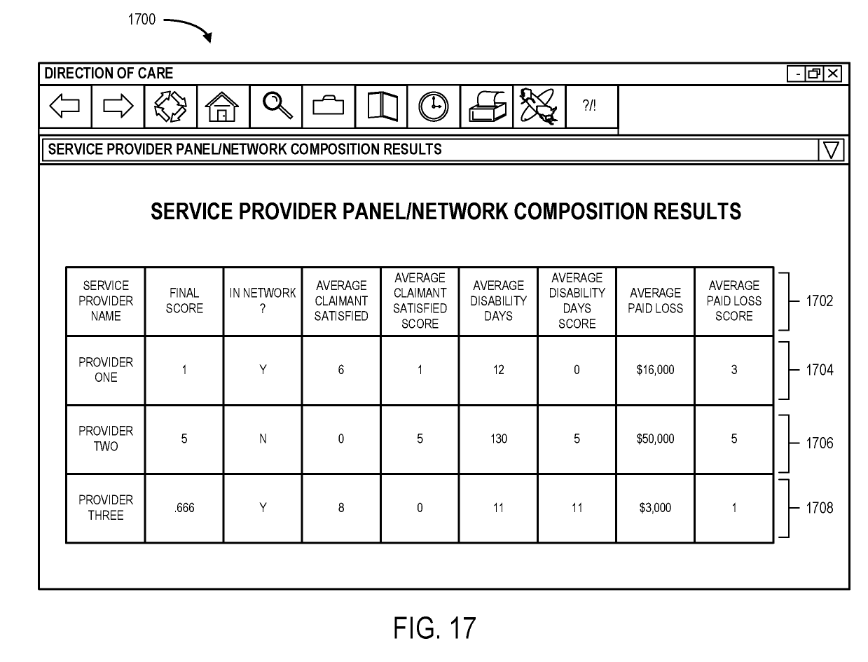

Referring now to both FIG. 14 and FIG. 17, FIG. 17 shows an example user interface element 1700 that may be used to display data that describes the composition of an example service provider panel or network on a display device (step 1418). The example user interface element 1700 includes a header row area 1702, a first row area 1704, a second row area 1706, and a third row area 1708. The user interface element 1700 of FIG. 17 shows service provider network composition data that relates to three example service providers, Provider One, Provider Two, and Provider Three. The first row area 1704 shows data that relates to Provider One; Provider One has an average claimant satisfaction score of one, an average disability days score of zero, and an average paid loss score of three. These scores may be determined using the example parameters described above with reference to Table I and Table II. These scores, when averaged, result in the final score of one, as shown in the first row area 1704. The second row area 1706 and the third row area 1708 show corresponding data for Provider Two and Provider Three, respectively. In this example, a threshold final value of three may have been used to determine whether or not a service provider should be included in the service provider panel or network. According to this example, and as shown in the row areas 1702, 1704, 1706 in the user interface element 1700, Provider One and Provider Three are included in the service provider panel or network, while Provider Two is not included in the service provider panel or network.

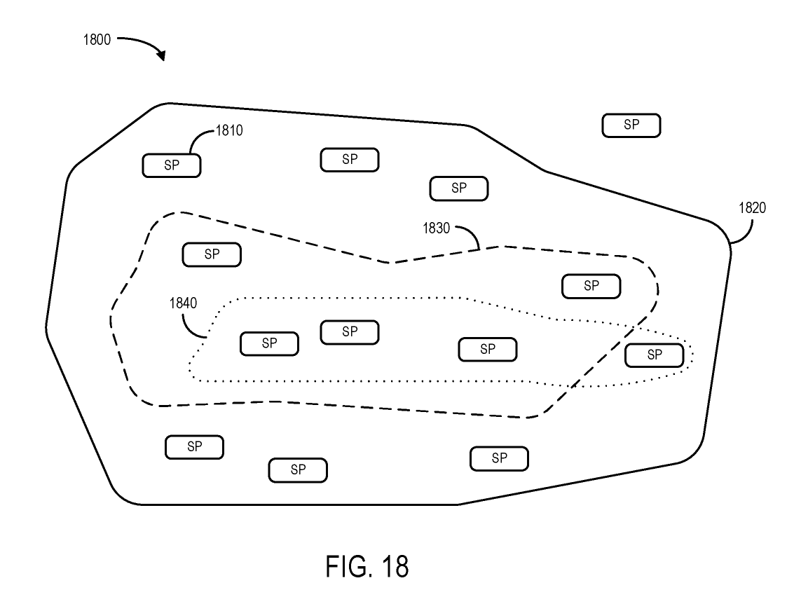

According to some embodiments described herein, service providers might be categorized into various sets and sub-sets of providers (and claimants might be directed or referred to various sub-sets as appropriate). For example, FIG. 18 illustrates 1800 a set of service providers 1810 in accordance with some embodiments. In particular, the service providers 1810 might include a set of Preferred Provider Organization (“PPO”) service providers 1820 that may include providers who are not currently part of a medical provider network. The PPO service providers 1820 might include a sub-set of providers 1810 who have been designated (e.g., by an insurer) as PPO network providers 1830 (e.g., including those selected according any of the embodiments described herein). The PPO network providers 1830 might further include a sub-set of providers 1810 who have been designated (e.g., by the insurer) as select network providers 1840 (e.g., which may, according to some embodiments, include at least some service providers 1810 that are not included in the PPO service providers 1820).

According to some embodiments, the PPO network providers 1830 might be constructed, for example, using a multi-variate model to design a network based on both an insurer's internal data and third-party data to provide better care at a lower cost (on average). Such an approach may enable an insurer to guide claimants to receive direct care from these service providers 1830 (focusing on primary treaters) based on claim outcomes (e.g., treatment duration, medical severity, indemnity severity, claim closure, etc.). The select network providers 1840 might be created, according to some embodiments, based on behaviors that might indicate improper provider actions (e.g., by creating “do not use” lists to exclude when providers with anomalous outcomes are identified based on data internal to the insurer) using outcome outlier identification processes and/or clustering data (e.g., medical bills, office visits, etc.). Note that the select network providers 1840 might be based on both claims outcomes and behavioral outcomes (e.g., a number of physical therapy visits, a number of office visits, prescription data, etc.).

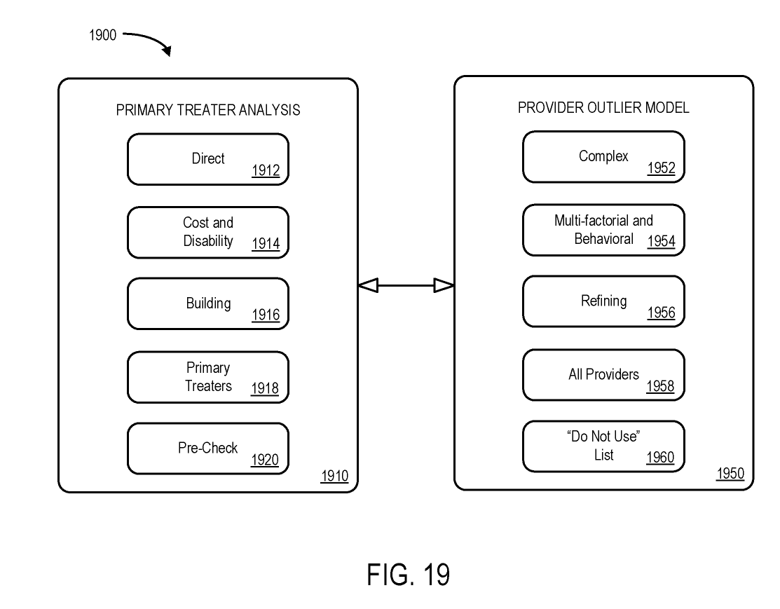

FIG. 19 provides examples 1900 of assessment methodologies according to some embodiments. In particular, a primary treater analysis 1910 might include direct analysis 1912 (to select the best providers), a cost and disability analysis 1914 (based on a total cost of claims and durations of disabilities), a building analysis 1916, a primary treaters analysis 1918 (e.g., identified by analytics including information from medical coding, psychosocial modes, opioid management approaches, evidence-based medicine, an analysis of performance, etc.), and/or a pre-check analysis 1920 (to identify cases prior to being referred to particular service providers). A provider outlier model 1950 might include a complex analysis 1952, a multi-factorial analysis 1954 (e.g., to examine comorbidity and similar situations), a refining analysis 1956 (to limit and/or refine the results from the complex analysis 1952 and/or multi-factorial analysis), an all providers analysis 1958, and/or a “do not use” list 1960 (e.g., a list of medical service provides who should not be considered when making referrals for a claimant on a temporary, time-limited, or permanent basis).

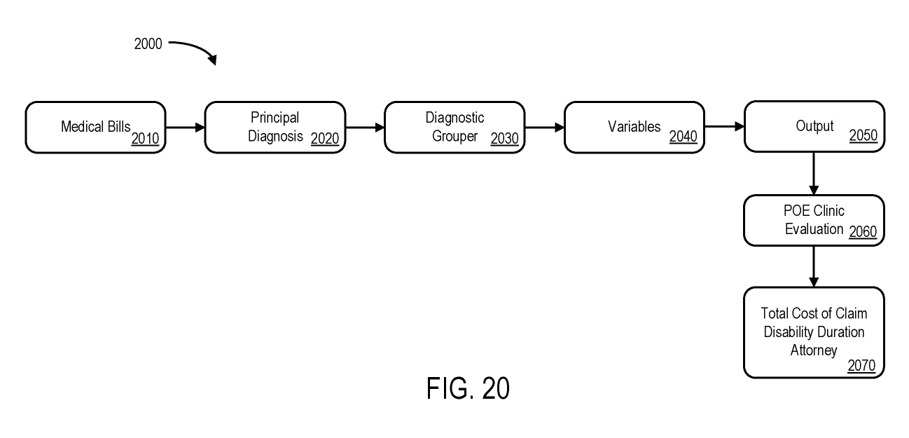

FIG. 20 is an information flow 2000 diagram illustrating a provider outcome methodology in accordance with some embodiments. A principle diagnosis 2020 may receive information about medical bills 2010. The principal diagnosis 2020 might, for example, be based on International Statistical Classification of Diseases and Related Health Problems (“ICD”) codes. For example, the principal diagnosis 2020 might be associated with a first recorded code, a last recorded code, the code that appears on the greatest number medical bills 2010 for a claimant, etc. Other embodiments might utilize World Health Organization International Classification of External Causes of Injury (“ICECI”) codes or United States Bureau of Labor Statistics Occupational Injury and Illness Classification System (“OIICS”) codes.

A diagnostic grouper 2030 may then assign a principal diagnosis to a diagnostic group. For example, the diagnostic grouper 2030 might examine a set of claims with the following characteristics: the injury occurred in California; the claim is closed or has reached a certain level of completeness; and the injury occurred between the years 2010 and 2015. According to some embodiments, certain type of claims might be excluded from the diagnostic grouper 2030, such as claims associated with: a denial of benefits; death; a permanent total disability; a dental injury; a primary psychiatric claim; a “catastrophic” injury as described herein; a lack of medical payment history; a total benefit amount above a predetermined threshold value; etc.

According to some embodiments, catastrophic claims may be excluded from the claims considered by the grouper 2030. The term “catastrophic” might refer to, for example, a claim for which severity and outcomes are expected to be poor based on the initial injury. For example, a catastrophic claim might need immediate hospitalization and be associated with at least one of the following: a Traumatic Brain Injury (“TBI”); a Spinal Cord Injury (“SCI”); major third degree burns; an amputation of a limb; a loss of an eye; or multiple trauma with fractures, internal bleeding, and/or internal organ damage. Note that because the list of ICD codes required to cover all these diagnoses might be substantial, embodiments might also look at one or more surrogate markers, such as an emergency room claim that arrives in a unit less than three months after date of injury. Another surrogate marker might comprise claims that have a medical spend of more than $100,000 in the first six months.

The grouper 2030 might, according to some embodiments, identify 10 to 20 principal diagnostic groups based on frequency. These groups might reflect clustering around clinical and/or financial similarities. For example, a wrist contusion, wrist sprain, wrist strain, and wrist pain diagnosis might be managed very similarly from a clinical point of view and result in similar financial outcomes. Note that the grouper 2030 might not require diagnostic equivalence; instead the grouper 2030 might look for diagnostic clustering. Depending on the chosen method to identify principal diagnosis, the system may build a cross-walk of diagnoses to groupings. Some examples of diagnostic groups that might be identified by the grouper 2030 include: low back pain; neck pain; shoulder pain; wrist pain, sprain, or strain; carpal tunnel syndrome pain; hip pain, sprain, or strain; knee pain, sprain, or strain; ankle pain, sprain, strain; a hernia; a corneal abrasion; and a puncture wound on a claimant's foot.

The flow 2000 may then assign variables 2040 such as one or more severity variables, comorbidity variables, age, gender, etc. to generate an output 2050. With respect to severity variables, embodiments might employ segmentation (e.g., core, intermediate, and high exposure segmentation) to identify particular claims. Other embodiments might examine claim type (medical only claims, lost time claims, permanent partial disability claims, etc.) to determine severity. With respect to comorbidity variables, note that the presence of a comorbidity may increase medical cost. Some examples of comorbidities include: obesity; substance abuse; diabetes mellitus; hypertension; and Chronic Obstructive Pulmonary Disease (“COPD”).

At 2060, a Point of Entry (“POE”) clinic evaluation may be performed. For example, the flow 2000 may assign a total cost of claim, a disability duration and/or a presence or absence of attorney as outcomes at 2070 and rate the POE clinic based on the outcomes. Note that the POE doctor or clinic may have a substantial impact on the final outcome of a claim. The POE clinic might be, for example, associated with a set of occupational physicians, sports medicine specialists, family or internal medicine doctors, etc. who manage referrals to diagnostic services, physical medicine, and/or specialists. According to some embodiments, the POE clinic (rather than an individual provider) might be evaluated because the insurer might refer claimants to a clinic (with the choice of specific provider left to chance based on who is available at the time of service). Typically, clinics manage their providers and they have consistent practice, prescribing, and referral patterns and allow the insurer to aggregate more claims to clinics (making outcome analysis more meaningful and more statistically valid).

According to some embodiments, data mining might be used to classify/group claims and/or to rate or review providers. As used herein, the phrase “data mining” may refer to the classical types of data manipulation including relational data, formatted and structured data. Moreover, data mining generally involves the extraction of information from raw materials and transformation into an understandable structure. Data mining may be used to analyze large quantities of data to extract previously unknown, interesting patterns such as groups of data records, unusual records, and dependencies. Data mining can involve six common classes of tasks: 1) anomaly detection; 2) dependency modeling; 3) clustering; 4) classification; 5) regression, and 6) summarization.

Anomaly detection, also referred to as outlier/change/deviation detection may provide the identification of unusual data records, that might be interesting or data errors that require further investigation.

Dependency modeling, also referred to as association rule learning, searches for relationships between variables, such as gathering data on customer purchasing habits. Using association rule learning, associations of products that may be bought together may be determined and this information may be used for marketing purposes.

Clustering is the task of discovering groups and structures in the data that are in some way or another “similar”, without using known structures in the data.

Classification is the task of generalizing known structure to apply to new data. For example, an e-mail program might attempt to classify an e-mail as “legitimate” or as “spam.”

Regression attempts to find a function which models the data with the least error.

Summarization provides a more compact representation of the data set, including visualization and report generation.

According to some embodiments, machine learning may perform pattern recognition on data or data sets contained within raw materials. This can be, for example, a review for a pattern or sequence of labels for claims. Machine learning explores the construction and study of raw materials using algorithms that can learn from and make predictions on such data. Such algorithms may operate using a model in order to make data-driven predictions or decisions (rather than strictly using static program instructions). Machine learning may include processing using clustering, associating, regression analysis, and classifying in a processor. The processed data may then be analyzed and reported.

As used herein the phrase “text mining may refer to using text from raw materials, such as a claim handling narrative. Generally, text mining involves unstructured fields and the process of deriving high-quality information from text. High-quality information is typically derived through the devising of patterns and trends through means such as statistical pattern learning. Text mining generally involves structuring the input data from raw materials, deriving patterns within the structured data, and finally evaluation and interpretation of the output. Text analysis involves information retrieval, lexical analysis to study word frequency distributions, pattern recognition, tagging/annotation, information extraction, data mining techniques including link and association analysis, visualization, and predictive analytics. The overarching goal is, essentially, to turn text into data from raw materials for analysis, via application of Natural Language Processing (“NLP”) and analytical methods. A typical application is to scan a set of documents written in a natural language and either model the document set for predictive classification purposes or populate a database or search index with the information extracted.

According to some embodiments, an outlier engine receives data input from a machine learning unit that establishes pattern recognition and pattern/sequence labels for a claim, for example. This may include billing, repair problems, and treatment patterns, etc. This data may be manipulated within the outlier engine, such as by providing a multiple variable graph as will be described herein below. The outlier engine may provide the ability to identify or derive characteristics of the data, find clumps of similarity in the data, profile the clumps to find areas of interest within the data, generate referrals based on membership in an area of interest within the data, and/or generate referrals based on migration toward and area of interest in the data. These characteristics may be identified or derived based on relationships with other data points that are common with a given data point. For example, if a data point is grouped with another data point, the attributes of the other data point may be derived to be with the data point. Such derivation may be based on clumps of similarity, for example. Such an analysis may be performed using a myriad of scores as opposed to a single variable.

According to some embodiments, outlier analysis may be performed on unweighted data (e.g., with no variable to model to). This analysis may include identifying and/or calculating a set of classifying characteristics. With respect to insurance claims, the classifying characteristics might include loss state claimant age, injury type, and reporting.

Additionally, these classifying characteristics may be calculated by comparing a discrete observation against a benchmark and use the differences as the characteristic. For example, the number of line items on a bill compared to the average for bills of the type may be determined. A ratio may be used so that if the average number of line items is 4 and a specific bill has 8, the characteristic may be the ratio, in the example a value of 2.

An algorithm may be used to group the target, such as claims for example, into sets with shared characteristics. Each group or cluster of data may be profiled and those that represent sets of observations that are atypical are labeled as outliers or anomalies. A record may be made for each observation with all of the classifying characteristics, and values used to link the record back to the source data. The label for the cluster that the observation belonged to, whether it is normal or an outlier with a data of classification is recorded.

An outlier engine may be used, for example, to utilize characteristics such as binary questions, claim duration peer group metric to measure the relative distance from a peer group, claims that have high ratios, K means clustering, principle compost self-organic. For example, when performing invoice analytics on doctor invoices to check for conformance including determining if doctors are performing the appropriate testing, a ratio of duration of therapy to average duration therapy may be utilized. A score of 1 may be assigned to those ratios that are the same as the average, a score of 2 may be assigned to those ratios that are twice as long and 0.5 assigned to the ratios that are half as long. An outlier engine may then group data by the score data point to determine if a score of 2 finds similarity with other twice as long durations, which classification enables the data to provide other information that may accompany this therapy including, by way of example, a back injury.

The ratio of billed charges may also be compared to the average. A similar scoring system may be utilized where a score of 1 is assigned to those ratios that are the same as the average, a score of 2 may be assigned to those ratios that are twice as high and 0.5 assigned to the ratios that are half as much. Similarly, the ratio of the number of bills/claim to average may also be compared and scored. The measure of whether a procedure matches a diagnosis may also be compared and scored. The billed charges score may be used based on the diagnosis to determine if a given biller is consistently providing ratios that are twice as high as others.

According to one aspect, things that do not correlate may be dropped as unique situations. In a perfect scenario, collinearity may be achieved with mutually exclusive independent variables. That is duplicative variables that correlate in in their outcomes may be dropped. An outlier engine may also utilize a predictive model. As is generally understood in the art, a predictive model is a model that utilizes statistics to predict outcomes. For example, an outlier engine may use a predictive model that may be embedded in workflow.

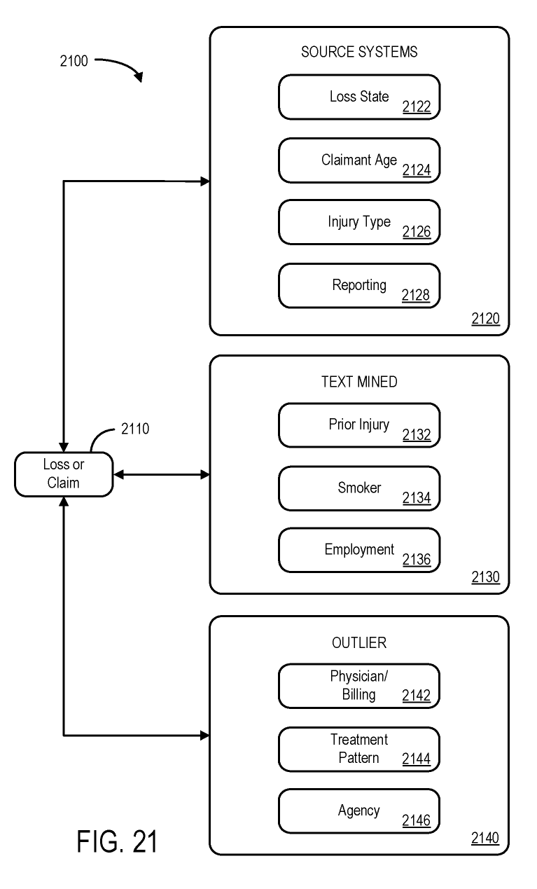

FIG. 21 illustrates an example data system 2100 for an outlier engine 830. The outlier engine becomes, along with the data available from source systems and characteristics derived through text mining, a source of information describing a claim characteristic 2110 including an injury type, location, claimant age, etc. that is the subject of a predictive model. Predictor variables may include source systems 2120, text mined data 2130, and outlier data 2140. Using an insurance claim as an example, the source systems 2120 may include loss state 2122, claimant age 2124, injury type 2126 and reporting 2128 including the channel the claim was reported through (e.g., telephone call, web, or attorney contact). The data may be considered standard data from text mined data 2130. Using claim as an example, prior injury 2132, smoking history 2134, and employment status 2136 may be included.

The outlier 2140 characteristics may also be included. The outlier data 2140 may include physician/billing information 2142, such as if a physician is a 60-70% anomaly biller, treatment pattern 2144, such as if the treatment pattern is an anomaly, and the agency 2144, such as if the agency is an outlier for high loss ratio insureds.

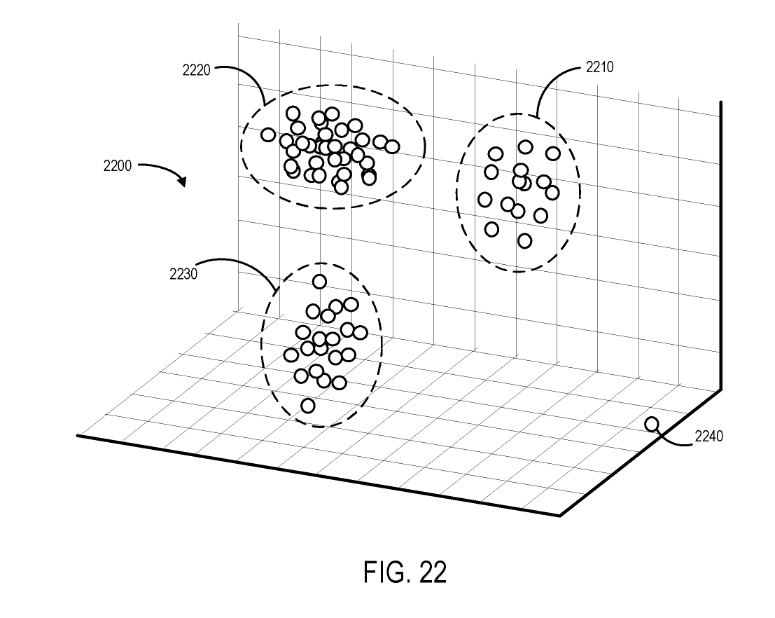

Referring now also to FIG. 22, an outlier engine output 2200 is illustrated with a normative area 2210 wherein all target characteristics are typical, a first area of interest 2220 wherein there is an unusual procedure for the provider specialty and an unusual pattern of treatment for the injury, a second area of interest 2230 wherein there is an unusual number of invoices and the presence of co-morbidity/psycho-social condition, and outlier 2240 that is too far from any clump and includes a unique profile.

For example, an invoice belonging to a set may be analyzed and presented with characteristics of that invoice including doctor and treatment for example as well as the injury suffered. The axes shown in FIG. 22 may be defined by attributes of the group of invoices. Data may be grouped based on sharing attributes or qualities, like duration of treatment for an injury for example. Other data may fall in between groups as described. The groupings of data become an important attribute of the data fitting that group.

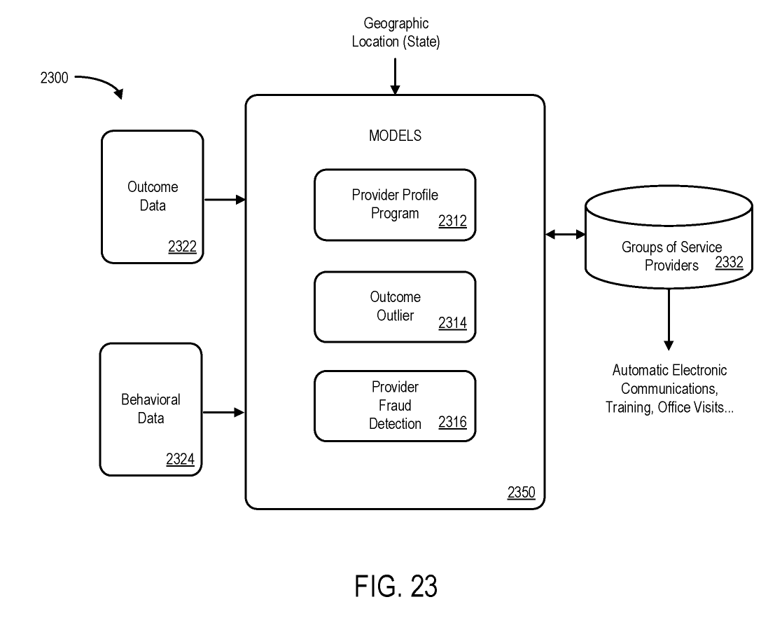

FIG. 23 is a system block diagram of a performance monitoring system 2300 according to some embodiments. The system 2300 includes models 2350 that receive outcome data 2322, behavioral data 2324, and a geographic location (e.g., a state within which a loss occurred). The models 2350 might include, for example, a provider profile program 2312, an outcome outlier 2314, and a provider fraud detection element 2316. Based on the received data and the models 2350, the system 2300 may store information into a groups of service providers data store 2332 (e.g., a list of preferred medical service provider clinics along with a list of clinics that may need improvement). Based on the information in the groups of service providers data store 2332, the system 2300 may, for example, automatically route electronic messages and training materials (e.g., interactive smartphone applications) to clinics.

According to some embodiments, the models may be associated with a diagnosis grouping platform to group similar claims handled by a panel of medical service providers and/or a rating platform to, based on groups of similar claims, review performance of each medical service provider in the panel. The claim grouping may be based on, for example: a principal diagnosis, a severity variable, a comorbidity variable, age, gender, claim cost, disability duration, a geographic location, claim frequency for a type of injury, etc. Moreover, each medical service provider may be associated with a POE medical clinic having a set of physicians, nurses, and/or physical therapists. According to some embodiments, each medical service provider is associated with a surgeon and/or a medical specialist (e.g., providing medical services “downstream” from a patient's original POE). In this way, the system 2300 may route or guide the most important claims to the highest rated providers. According to some embodiments, the rating platform may continuously designate a sub-set of the medical service providers as preferred and automatically identify a sub-set of the medical service providers as requiring at least one intervention action. Note that the rating platform might be an outlier identifier to recognize medical service providers with anomalous outcomes and/or a volatility detector (e.g., to detect medical service providers with unusually variable costs). According to some embodiments, the rating platform reviews performance based at least in part on claim outcomes, behavioral outcomes, a number of physical therapist visits, a number of office visits, prescription data, claimant feedback information, medical service provider feedback information, social media data, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to adjust output information distributed via a distributed communication network by an automated back-end application computer server, comprising:
(a) an available resource computer store, storing, for each of a plurality of potentially available resource units, detailed resource information including a resource preference indication;
(b) a resource performance metric computer store, storing, for each of the plurality of potentially available resource units, at least one performance metric score value;
(c) a communication port to facilitate an exchange of electronic messages with the available resource computer store and the resource performance metric computer store via the distributed communication network;
(d) the back-end application computer server, coupled to the communication port and programmed to:
(i) for each of the plurality of potentially available resource units, automatically access the at least one performance metric score value in the resource performance metric computer store, wherein the performance metric score value represents at least one of a magnitude of resource provided and a length of time during which resource is provided,
(ii) based on the at least one performance metric score value, automatically update a state of the resource preference indication in the available resource computer store, and
(iii) automatically arrange to adjust at least one output parameter in accordance with the updated state of the resource preference indication;
(e) a diagnosis grouping platform to group similar events handled by a subset of the potentially available resource units; and
(f) a rating platform to, based on groups of similar events, review performance of each potentially available resource unit in the subset.

2. The system of claim 1, wherein said adjustment to the at least one output parameter is associated with a search result list.

3. The system of claim 2, wherein said adjustment to the at least one output parameter includes at least one of: (i) removal of a potentially available resource unit from the search result list and (ii) a re-ordering of a potentially available resource unit in the search result list.

4. The system of claim 1, wherein the back-end application computer server is associated with an insurer and the available resource computer store comprises an available medical service provider computer store that contains, for each of a plurality of potentially available medical service providers, detailed resource information.

5. The system of claim 4, wherein the back-end application computer server is associated with at least one of: workers' compensation insurance, automobile insurance, short term disability insurance, and long term disability insurance.

6. The system of claim 4, wherein the detailed resource information includes at least one of: a potentially available medical service provider name, a potentially available medical service provider address, a potentially available medical service provider communication address, a potentially available medical service provider specialty, a potentially available medical service provider language, and potentially available medical service provider insurance information.

7. The system of claim 4, wherein the at least one performance metric score value is associated with at least one of: an average claimant satisfaction, an average claim adjuster satisfaction, an average employer satisfaction, a frequency of surgery, an average amount of lost time from work, a death rate, a bad outcome rate, colleague recommendations, credential verification, a quality of an associated hospital, a medical cost, a length of disability, and an amount of deviation from standards based medicine and adherence to guidelines.

8. The system of claim 4, wherein the at least one performance metric score is associated with at least one of: an internal physician prescription dispensing score, an internal physician outlier score, an internal utilization review, an external healthcare dataset, an external Medicare dataset, and a vender dataset.

9. The system of claim 4, wherein said arranging to adjust the at least output parameter is performed on a periodic basis.

10. The system of claim 4, wherein the said adjustment to the at least one output parameter is associated with creation of a panel of medical service providers.

11. The system of claim 10, wherein the creation of the panel of medical service providers is based at least in part on a geographic location associated with an insurance claim.

12. The system of claim 10, wherein the creation of the panel of medical service providers is performed prior to receipt of an insurance claim.

13. The system of claim 10, wherein the creation of the panel of medical service providers is performed responsive to receipt of an insurance claim.

14. The system of claim 1, wherein said grouping is based at least in part on two or more of: (i) a principal diagnosis, (ii) a severity variable, (iii) a comorbidity variable, (iv) age, (v) gender, (vi) claim cost, (vii) disability duration, (viii) a geographic location, and (ix) claim frequency for a type of injury.

15. The system of claim 1, wherein each medical service provider is associated with at least one of: (i) a point of entry medical clinic having a set of physicians, nurses, and/or physical therapists, (ii) a surgeon, or (iii) a medical specialist.

16. The system of claim 1, wherein the rating platform is to continuously designate a sub-set of the medical service providers as preferred.

17. The system of claim 1, wherein the rating platform is to automatically identify a sub-set of the medical service providers as requiring at least one intervention action.

18. The system of claim 1, wherein the rating platform comprises at least one of: (i) an outlier identifier to recognize medical service providers with anomalous outcomes, and (ii) a volatility detector.

19. The system of claim 1, wherein rating platform reviews performance based at least in part on at least two of: (i) claim outcomes, (ii) behavioral outcomes, (iii) a number of physical therapist visits, (iii) a number of office visits, (iv) prescription data, (v) claimant feedback information, (vi) medical service provider feedback information, and (vii) social media data.

20. A computerized method to adjust output information distributed via a distributed communication network by an automated back-end application computer server, comprising:
storing, for each of a plurality of potentially available resource units, detailed resource information including a resource preference indication;
storing, for each of the plurality of potentially available resource units, at least one performance metric score value;
for each of the plurality of potentially available resource units, automatically accessing, by the back-end application computer server, the at least one performance metric score value in a resource performance metric computer store, wherein the performance metric score value represents at least one of a magnitude of resource provided and a length of time during which resource is provided;
based on the at least one performance metric score value, automatically updating, by the back-end application computer server, a state of the resource preference indication in an available resource computer store; and
automatically arranging to adjust, by the back-end application computer server, at least one output parameter in accordance with the updated state of the resource preference indication.

21. The method of claim 20, wherein said adjustment to the at least one output parameter is associated with a search result list and comprises at least one of removal of a potentially available resource unit from the search result list and a re-ordering of a potentially available resource unit in the search result list, and further wherein the back-end application computer server is associated with an insurer and the available resource computer store comprises an available medical service provider computer store that contains, for each of a plurality of potentially available medical service providers, detailed resource information.

22. A system to adjust output information distributed via a distributed communication network by an automated back-end application computer server, comprising:
(a) an available resource computer store, storing, for each of a plurality of potentially available resource units, detailed resource information including a resource preference indication;
(b) a resource performance metric computer store, storing, for each of the plurality of potentially available resource units, at least one performance metric score value, including at least one performance metric score value that represent at least one of a magnitude of resource provided and a length of time during which resource is provided;
(c) a communication port to facilitate an exchange of electronic messages with the available resource computer store and the resource performance metric computer store via the distributed communication network;
(d) a diagnosis grouping platform to receive information via the communication port and to group similar events handled by a subset of the potentially available resource units based at least in part on performance metric score values; and
(e) a rating platform to, based on groups of similar events, review performance of each potentially available resource unit in the subset.

23. The system of claim 22, wherein the potential available resource units are potentially available medical service providers, the magnitude of resource provide represents a medical cost, the length of time during which resource is provided represents a length of disability, the subset of the potentially available medical service providers is a panel of medical service providers, and events are insurance claims.
